(19) United States
(12) Patent Application Publication
(10) Pub. No.: US 2025/0279891 A1
(43) Pub. Date: Sep. 4, 2025

(54) APPARATUS AND METHOD OF EXECUTING TOKEN DATA

(71) Applicant: PassEntry Limited, Downside (GB)

(72) Inventor: Nicholas Cary, Downside (GB)

(73) Assignee: PassEntry Limited, Downside, OT (GB)

(21) Appl. No.: 18/591,134

(22) Filed: Feb. 29, 2024

(51) Int. Cl. H04L 9/32

(52) U.S. Cl. CPC H04L 9/3213; H04L 9/3239

(57) ABSTRACT

An apparatus and method for executing token data are provided. The apparatus includes at least a processor and a memory communicatively connected to the at least a processor, wherein the memory contains instructions configuring the at least a processor to initiate a communication channel between a first device and a second device, extract token data and user data using the communication channel, wherein the user data includes primary instrument data and secondary instrument data, update the token data as a function of the user data, execute the updated token data as a function of the primary instrument data of the user data and update the secondary instrument data of the user data as a function of the execution of the updated token data.

### FIELD OF THE INVENTION

The present invention generally relates to the field of data execution. In particular, the present invention is directed to apparatus and method of executing token data.

### BACKGROUND

The growth of digital data and the increasing complexity of data processing tasks have necessitated innovative approaches to improve the efficiency of data execution processes. Current computational solutions can do no better than present a tradeoff between compromises, requiring skilled human intervention where humanly possible to achieve optimal results, and forgoing such results completely where human intervention cannot suffice.

### SUMMARY OF THE DISCLOSURE

In an aspect, an apparatus for executing token data is disclosed. The apparatus includes at least a processor and a memory communicatively connected to the at least a processor, wherein the memory contains instructions configuring the at least a processor to initiate a communication channel between a first device and a second device, extract token data and user data using the communication channel, wherein the user data includes primary instrument data and secondary instrument data, update the token data as a function of the user data, execute the updated token data as a function of the primary instrument data of the user data and update the secondary instrument data of the user data as a function of the execution of the updated token data.

In another aspect, a method for executing token data is disclosed. The method includes initiating, using at least a processor, a communication channel between a first device and a second device, extracting, using the at least a processor, token data and user data using the communication channel, wherein the user data includes primary instrument data and secondary instrument data, updating, using the at least a processor, the token data as a function of the user data, executing, using the at least a processor, the updated token data as a function of the primary instrument data of the user data and updating, using the at least a processor, the secondary instrument data of the user data as a function of the execution of the updated token data.

These and other aspects and features of non-limiting embodiments of the present invention will become apparent to those skilled in the art upon review of the following description of specific non-limiting embodiments of the invention in conjunction with the accompanying drawings.

### BRIEF DESCRIPTION OF THE DRAWINGS

For the purpose of illustrating the invention, the drawings show aspects of one or more embodiments of the invention. However, it should be understood that the present invention is not limited to the precise arrangements and instrumentalities shown in the drawings, wherein:

FIG. 1 illustrates a block diagram of an exemplary apparatus of executing token data;

FIG. 2 illustrates an exemplary user interface displaying updated secondary instrument data on a second device;

FIG. 3 illustrates a block diagram of an exemplary machine-learning process;

FIG. 4 illustrates an exemplary neural network;

FIG. 5 illustrates an exemplary node of neural network;

FIG. 6 illustrates a flow diagram of an exemplary method of executing token data; and

FIG. 7 is a block diagram of a computing system that can be used to implement any one or more of the methodologies disclosed herein and any one or more portions thereof.

The drawings are not necessarily to scale and may be illustrated by phantom lines, diagrammatic representations and fragmentary views. In certain instances, details that are not necessary for an understanding of the embodiments or that render other details difficult to perceive may have been omitted.

### DETAILED DESCRIPTION

At a high level, aspects of the present disclosure are directed to systems and methods executing token data. The apparatus includes at least a processor and a memory communicatively connected to the at least a processor, wherein the memory contains instructions configuring the at least a processor to initiate a communication channel between a first device and a second device, extract token data and user data using the communication channel, wherein the user data includes primary instrument data and secondary instrument data, update the token data as a function of the user data, execute the updated token data as a function of the primary instrument data of the user data and update the secondary instrument data of the user data as a function of the execution of the updated token data. Exemplary embodiments illustrating aspects of the present disclosure are described below in the context of several specific examples.

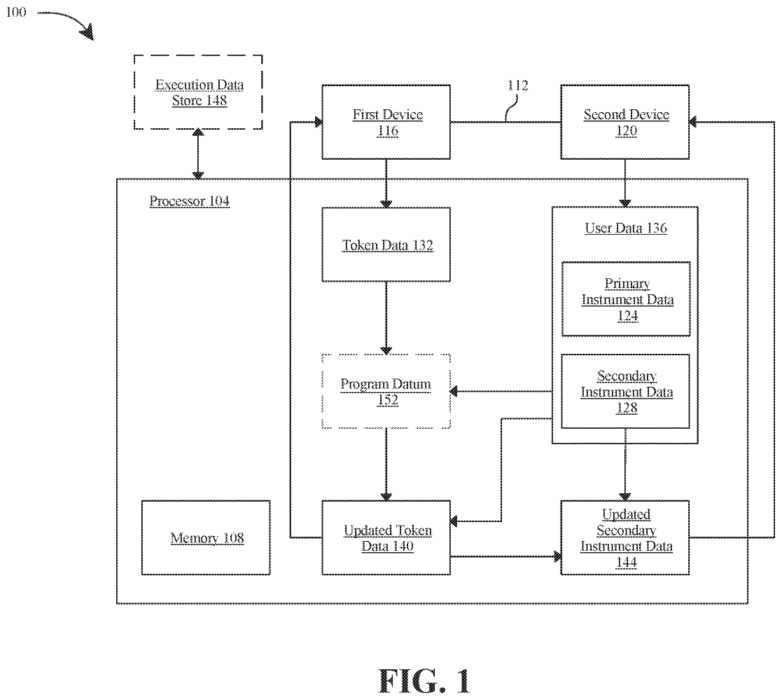

Referring now to FIG. 1, an exemplary embodiment of an apparatus 100 for executing token data is illustrated. Apparatus 100 includes at least a processor 104. Processor 104 may include, without limitation, any processor described in this disclosure. Processor 104 may be included in a computing device. Processor 104 may include any computing device as described in this disclosure, including without limitation a microcontroller, microprocessor, digital signal processor (DSP) and/or system on a chip (SoC) as described in this disclosure. Processor 104 may include, be included in, and/or communicate with a mobile device such as a mobile telephone or smartphone. Processor 104 may include a single computing device operating independently, or may include two or more computing device operating in concert, in parallel, sequentially or the like; two or more computing devices may be included together in a single computing device or in two or more computing devices. Processor 104 may interface or communicate with one or more additional devices as described below in further detail via a network interface device. Network interface device may be utilized for connecting processor 104 to one or more of a variety of networks, and one or more devices. Examples of a network interface device include, but are not limited to, a network interface card (e.g., a mobile network interface card, a LAN card), a modem, and any combination thereof. Examples of a network include, but are not limited to, a wide area network (e.g., the Internet, an enterprise network), a local area network (e.g., a network associated with an office, a building, a campus or other relatively small geographic space), a telephone network, a data network associated with a telephone/voice provider (e.g., a mobile communications provider data and/or voice network), a direct connection between two computing devices, and any combinations thereof. A network may employ a wired and/or a wireless mode of communication. In general, any network topology may be used. Information (e.g., data, software etc.) may be communicated to and/or from a computer and/or a computing device. Processor 104 may include but is not limited to, for example, a computing device or cluster of computing devices in a first location and a second computing device or cluster of computing devices in a second location. Processor 104 may include one or more computing devices dedicated to data storage, security, distribution of traffic for load balancing, and the like. Processor 104 may distribute one or more computing tasks as described below across a plurality of computing devices of computing device, which may operate in parallel, in series, redundantly, or in any other manner used for distribution of tasks or memory between computing devices. Processor 104 may be implemented, as a non-limiting example, using a “shared nothing” architecture.

With continued reference to FIG. 1, processor 104 may be designed and/or configured to perform any method, method step, or sequence of method steps in any embodiment described in this disclosure, in any order and with any degree of repetition. For instance, processor 104 may be configured to perform a single step or sequence repeatedly until a desired or commanded outcome is achieved; repetition of a step or a sequence of steps may be performed iteratively and/or recursively using outputs of previous repetitions as inputs to subsequent repetitions, aggregating inputs and/or outputs of repetitions to produce an aggregate result, reduction or decrement of one or more variables such as global variables, and/or division of a larger processing task into a set of iteratively addressed smaller processing tasks. Processor 104 may perform any step or sequence of steps as described in this disclosure in parallel, such as simultaneously and/or substantially simultaneously performing a step two or more times using two or more parallel threads, processor cores, or the like; division of tasks between parallel threads and/or processes may be performed according to any protocol suitable for division of tasks between iterations. Persons skilled in the art, upon reviewing the entirety of this disclosure, will be aware of various ways in which steps, sequences of steps, processing tasks, and/or data may be subdivided, shared, or otherwise dealt with using iteration, recursion, and/or parallel processing.

With continued reference to FIG. 1, apparatus 100 includes a memory 108 communicatively connected to processor 104. For the purposes of this disclosure, “communicatively connected” means connected by way of a connection, attachment or linkage between two or more relata which allows for reception and/or transmittance of information therebetween. For example, and without limitation, this connection may be wired or wireless, direct or indirect, and between two or more components, circuits, devices, systems, and the like, which allows for reception and/or transmittance of data and/or signal(s) therebetween. Data and/or signals therebetween may include, without limitation, electrical, electromagnetic, magnetic, video, audio, radio and microwave data and/or signals, combinations thereof, and the like, among others. A communicative connection may be achieved, for example and without limitation, through wired or wireless electronic, digital or analog, communication, either directly or by way of one or more intervening devices or components. Further, communicative connection may include electrically coupling or connecting at least an output of one device, component, or circuit to at least an input of another device, component, or circuit. For example, and without limitation, via a bus or other facility for intercommunication between elements of a computing device. Communicative connecting may also include indirect connections via, for example and without limitation, wireless connection, radio communication, low power wide area network, optical communication, magnetic, capacitive, or optical coupling, and the like. In some instances, the terminology “communicatively coupled” may be used in place of communicatively connected in this disclosure.

With continued reference to FIG. 1, memory 108 contains instructions configuring processor 104 to initiate a communication channel 112 between a first device 116 and a second device 120. In a non-limiting example, processor 104 may initiate communication channel 112 upon detecting user's intent to make a payment as described below. A “communication channel,” as used herein, is defined as a medium for conveying or transmitting information. In some cases, communication channel 112 may include wired or wireless communication, direct or indirect communication, and between two or more components, circuits, devices, systems, and the like, which allows for reception and/or transmittance of data and/or signal(s) therebetween. Data and/or signals therebetween may include, without limitation, electrical, electromagnetic, magnetic, video, audio, radio and microwave data and/or signals, combinations thereof, and the like, among others. Communication channel 112 may be achieved, for example and without limitation, through wired or wireless electronic, digital or analog, communication, either directly or by way of one or more intervening devices or components. Further, communication channel 112 may include electrically coupling or connecting at least an output of one device, component, or circuit (i.e. first device 116) to at least an input of another device, component, or circuit (i.e. second device 120). For example, and without limitation, using a bus or other facility for intercommunication between elements of a computing device. Communication channel 112 may also include indirect connections using, for example and without limitation, wireless connection, radio communication, low power wide area network, optical communication, magnetic, capacitive, or optical coupling, and the like. As a non-limiting example, communication channel 112 may include near field communication (NFC). For the purposes of this disclosure, “near-field communication” is a short-range wireless communication technology that allows data exchange between devices when they are in close proximity. As another non-limiting example, communication channel 112 may include BLUETOOTH, Wi-Fi, or the like. In a non-limiting example, communication channel 112 between first device 116 and second device 120 may be initiated when a user taps second device 120 on first device 116; for instance, without limitation, a tap may include physical action of placing second device 120 against first device 116 within the predetermined range to initiate communication channel while this signifies the user's readiness to engage in a payment process and authorizes a transfer of transaction data (i.e. primary instrument data 124, secondary instrument data 128, token data 132, user data 136, updated token data 140, updated secondary instrument data 144, or the like) to first device 116. In some embodiments, history of initiation of communication channel 112 may be stored in execution data store 148. In some embodiments, history of initiation of communication channel 112 may be displayed on second device 120.

With continued reference to FIG. 1, for the purposes of this disclosure, a “first device” is any device that manages sales transactions or processes payments. In some cases, first device 116 may be configured to display information, such as product information, transaction amount, and/or the like. In some embodiments, first device 116 may be NFC enabled to continuously listen for a tap or any action asking for communication from second device 120. As a non-limiting example, action asking for communication may indicate a user's intent to make a payment; for instance actions or signals indicating that a user is ready to complete a financial transaction. This may include, but is not limited to, physical action, verbal confirmation, digital action, biometric authentication, or any interaction with first device 116. Continuing the non-limiting example, this may be done directly by a user or through second device 120. In some embodiments, processor 104 may be implemented in first device 116. In some embodiments, processor 104 may be remote to first device 116 and communicatively connected to first device 116. In some cases, first device 116 may include a contactless card-reader or any other point-of-sale (POS) terminal. For the purposes this disclosure, a “point of sale” is a system that is configured to manage sales transactions and process payments. In some embodiments, POS may include a software running on a hardware such as but not limited to a mobile phone, tablet, laptop, desktop, and the like. As a non-limiting example, POS may be implemented in a personal device. As another non-limiting example, POS may be implemented in a shared device. As a non-limiting example, the shared devices may include desktop computers, kiosks, screens, tablets, cash registers, or the like.

With continued reference to FIG. 1, in some embodiments, first device 116 may include a cash register. For the purposes of this disclosure, a “cash register” is a mechanical or electronic device that is configured to process sales transactions and manage cash. As a non-limiting example, when a customer makes a purchase, a cashier may enter the details of the sale, such as the item(s) purchased, the price, and the amount of money tendered by the customer. The cash register, as a non-limiting example, then may calculate the total amount due, and the customer can pay by cash, credit/debit card, or other payment method. The cash register, as a non-limiting example, may keep a record of the transaction, including the date, time, and details of the sale, as well as any change given to the customer.

With continued reference to FIG. 1, in another embodiment, first device 116 may include a scanning device. For the purposes of this disclosure, a “scanning device” is a device for scanning a unique identifier. In some embodiments, the scanning device may be implemented in a POS. In some embodiments, the scanning device may include an illumination system, a sensor, and a decoder. The sensor in the scanning device may detect the reflected light from the illumination system and may generate an analog signal that is sent to the decoder. The decoder may interpret that signal, validate the unique identifier using the check digit, and convert it into text. This converted text may be delivered by the scanning device to a computing device holding a database of any information of a service, user, and the like. As a non-limiting example, the scanning device may include a pen-type reader, laser scanner, camera-based reader, charge-coupled device (CCD) reader, omni-directional barcode scanner, and the like. For example without limitation, the scanning device may include a mobile device with an inbuild camera such as without limitation, a phone, a tablet, a laptop, and the like. In some embodiments, the scanning device may include wired or wireless communication.

With continued reference to FIG. 1, for the purposes of this disclosure, a “second device” is any device a user uses to input data. As a non-limiting example, second device 120 may include a laptop, desktop, tablet, mobile phone, smart phone, smart watch, smart wallet, smart headset, or things of the like. As another non-limiting example, second device 120 may include primary instrument. For the purposes of this disclosure, a “primary instrument” is a physical or digital medium that allows a user to make transactions using currency. For instance, without limitation, primary instrument may include credit card, debit card, prepaid card, gift card, or the like that includes NFC. For instance, without limitation, a card (i.e. second device 120) may emit electromagnetic waves that contains credit card information (i.e. primary instrument data 124), which can be captured by POS system (i.e. first device 116). As another non-limiting example, second device 120 may include secondary instrument. For the purposes of this disclosure, a “secondary instrument” is a complementary physical or digital medium that provides a user with benefits, incentives, or rewards for transactions. For instance, without limitation, secondary instrument may include loyalty pass, reward card, or the like. In an embodiment, both primary instrument and secondary instrument may be initialized and saved on a digital wallet program installed on second device 120 (e.g., APPLE WALLET). In some cases, primary instrument may be manually selected by a user or automatically selected by default. In some cases, second device 120 may be configured to select at least a secondary instrument from a plurality of secondary instruments based on an identification of first device 116 or user may manually select a secondary instrument. For example, second device 120 may search for a Starbucks reward card when making a payment at the Starbucks. This may be done through an application processing interface (API). As used herein, an “application programming interface” is a set of functions that allow applications to access data and interact with external software components, operating systems, or microdevices, such as another web application or computing device.

With continued reference to FIG. 1, in some embodiments, second device 120 may include an interface configured to receive inputs from a user. As a non-limiting example, a user may include a customer of a store, a member of a service, or the like. In some embodiments, user may manually input any data into apparatus 100 using second device 120. In some embodiments, user may have a capability to process, store or transmit any information independently. In some cases, second device 120 may include microphone, camera, display, or the like that supports a user to input data; for instance, but not limited to, data that indicates a user's intent to make a payment as described above. In some embodiments, processor 104 may be implemented in second device 120.

With continued reference to FIG. 1, memory 108 contains instructions configuring processor 104 to extract token data 132 and user data 136 as a function of communication channel 112. For the purposes of this disclosure, “token data” is data related to a financial transaction. As a non-limiting example, token data 132 may include transaction amount. For example, and without limitation, token data 132 may include a monetary value associated with the transaction, indicating the cost of goods or services exchanged. In some cases, token data 132 may be stored in execution data store 148. In some cases, token data 132 may be retrieved from execution data store 148. In some cases, user may manually input token data 132. In some cases, processor 104 may extract token data 132 from first device 116 as communication channel 112 is initiated.

With continued reference to FIG. 1, in some embodiments, apparatus 100 may include an execution data store 148. As used in this disclosure, “execution data store” is a data structure configured to store data associated with the execution of token data. As a non-limiting example, execution data store 148 may store token data 132, user data 136, updated token data, primary instrument data 124, secondary instrument data 128, program datum, alert datum, user input, and the like. In one or more embodiments, execution data store 148 may include input or calculated information and datum related to execution of token data 132. In some embodiments, a datum history may be stored in execution data store 148. As a non-limiting example, the datum history may include real-time and/or previous inputted data related to execution of token data 132. In one or more embodiments, execution data store 148 may include real-time or previously determined data related to token data 132, user data 136, updated token data, primary instrument data 124, secondary instrument data 128, or the like. As a non-limiting example, execution data store 148 may include instructions from a user, who may be an expert user, a past user in embodiments disclosed herein, or the like, where the instructions may include examples of the data related to execution of token data 132.

With continued reference to FIG. 1, in some embodiments, processor 104 may be communicatively connected with execution data store 148. For example, and without limitation, in some cases, execution data store 148 may be local to processor 104. In another example, and without limitation, execution data store 148 may be remote to processor 104 and communicative with processor 104 by way of one or more networks. The network may include, but is not limited to, a cloud network, a mesh network, and the like. By way of example, a “cloud-based” system can refer to a system which includes software and/or data which is stored, managed, and/or processed on a network of remote servers hosted in the “cloud,” e.g., via the Internet, rather than on local severs or personal computers. A “mesh network” as used in this disclosure is a local network topology in which the infrastructure processor 104 connect directly, dynamically, and non-hierarchically to as many other computing devices as possible. A “network topology” as used in this disclosure is an arrangement of elements of a communication network. The network may use an immutable sequential listing to securely store execution data store 148. An “immutable sequential listing,” as used in this disclosure, is a data structure that places data entries in a fixed sequential arrangement, such as a temporal sequence of entries and/or blocks thereof, where the sequential arrangement, once established, cannot be altered or reordered. An immutable sequential listing may be, include and/or implement an immutable ledger, where data entries that have been posted to the immutable sequential listing cannot be altered.

With continued reference to FIG. 1, in some embodiments, execution data store 148 may include keywords. As used in this disclosure, a “keyword” is an element of word or syntax used to identify and/or match elements to each other. For example, without limitation, the keyword may include a name of a user or product in the instance that a user is looking for token data 132 or user data 136 related to a specific user or product. In another non-limiting example, the keyword may include a unique identifier of a user or product in an example that a user is looking for token data 132 or user data 136 related to a specific user or product. In some embodiments, processor 104 may be configured to query execution data store 148 using keyword to retrieve data. As a non-limiting example, processor 104 may query execution data store 148 using unique identifier of a user (i.e. keyword) to retrieve secondary instrument data 128. For the purposes of this disclosure, a “unique identifier” is an identifier that is unique for an object among others. As a non-limiting example, unique identifier may include a universal product code (barcode), radio-frequency identification (RFID), cryptographic hashes, primary key, a unique sequencing of alpha-numeric symbols, or anything of the like that can be used to identify a specific product. For the purposes of this disclosure, a “universal product code” is a method of representing data in a visual, machine-readable form. In an embodiment, the universal product code may include linear barcode. For the purposes of this disclosure, “linear barcode,” also called “one-dimensional barcode” is a barcode that is made up of lines and spaces of various widths or sizes that create specific patterns. In another embodiment, the universal product code may include matrix barcode. For the purposes of this disclosure, “matrix barcode,” also called “two-dimensional barcode” is a barcode that is made up of two dimensional ways to represent information. As a non-limiting example, the matrix barcode may include quick response (QR) code, and the like. Unique identifier may take the form of any identifier that uniquely corresponds to the purposes of apparatus 100; this may be accomplished using methods including but not limited to Globally Unique Identifiers (GUIDs), Universally Unique Identifiers (UUIDs), or by maintaining a data structure, table, or database listing all transmitter identifiers and checking the data structure, table listing, or database to ensure that a new identifier is not a duplicate.

With continued reference to FIG. 1, in some embodiments, execution data store 148 may be implemented, without limitation, as a relational database, a key-value retrieval database such as a NOSQL database, or any other format or structure for use as a database that a person skilled in the art would recognize as suitable upon review of the entirety of this disclosure. Database may alternatively or additionally be implemented using a distributed data storage protocol and/or data structure, such as a distributed hash table or the like. Database may include a plurality of data entries and/or records as described above. Data entries in a database may be flagged with or linked to one or more additional elements of information, which may be reflected in data entry cells and/or in linked tables such as tables related by one or more indices in a relational database. Persons skilled in the art, upon reviewing the entirety of this disclosure, will be aware of various ways in which data entries in a database may store, retrieve, organize, and/or reflect data and/or records as used herein, as well as categories and/or populations of data consistently with this disclosure.

With continued reference to FIG. 1, for the purposes of this disclosure, “user data” is data related to a user. As a non-limiting example, user data 136 may include user demographic information. For example, and without limitation, user data 136 may include age, gender, name, address, family, occupation, or the like. As another non-limiting example, user data 136 may include geolocation data. A “geolocation,” as used in this disclosure, is any global position system (GPS) of a device or an entity. For example, and without limitation, geolocation data may include location of user or second device 120. User data 136 includes primary instrument data 124. For the purposes of this disclosure, “primary instrument data” is any data related to a primary instrument. As a non-limiting example, primary instrument data 124 may include card number, CSV, card holder name, user signature, expiration date, and the like. User data 136 includes secondary instrument data 128. For the purposes of this disclosure, “secondary instrument data” is any data related to a secondary instrument. In some cases, secondary instrument data 128 may include information related to loyalty or rewards associated with a user. As a non-limiting example, secondary instrument data 128 may include loyalty or reward points balance, expiration date, promotion deals, discounts, exclusive offers, membership information, reward history, eligible promotions, hierarchy level, accumulated execution number, and the like. For the purposes of this disclosure, a “hierarchy level” is a tier or category of a user that signifies the user's standing based on their engagement, spending, or other criteria. For example, and without limitation, hierarchy level may include entry, intermediate, elite level, or any labels of level there can be. For the purposes of this disclosure, an “accumulated execution number” is the total number of points, or other types of rewards that a customer has accumulated. For example, and without limitation, accumulated execution number may include accumulated points, monetary value, or the like. In some cases, user data 136 may be retrieved from execution data store 148. In some cases, user may manually input user data 136. In some cases, processor 104 may extract user data 136 from second device 120 as communication channel 112 is initiated.

With continued reference to FIG. 1, memory 108 contains instructions configuring processor 104 to update token data 132 as a function of user data 136. In a non-limiting example, “updating” token data 132 refers to modifying the cost of goods or services to be paid by a user or second device 120. For example, and without limitation, updating token data 132 may include redeeming rewards or applying discounts to token data 132. For example, and without limitation, if secondary instrument data 128 includes accumulated execution number $11 and token data 132 includes $40, processor 104 may update token data 132 to $29. In some embodiments, user may manually update token data 132. In some embodiments, processor 104 may automatically update token data 132. In some cases, processor 104 may update token data 132 as a function of user input. As a non-limiting example, user input may include a portion of accumulated execution number of secondary instrument data 128 that a user wants to use to update token data 132. For example, and without limitation, if user input includes $5 (i.e. a portion of accumulated execution number) while secondary instrument data 128 includes $20, processor 104 may update token data 132 from $40 to $35. Then, continuing the non-limiting example, processor 104 may update secondary instrument data 128 of user data 136 as a function of the update of token data 132. For example, and without limitation, continuing the previous example, as $5 (i.e. user input) of secondary instrument data 128 was used to update token data 132, processor 104 may update secondary instrument data 128 from $20 to $15. In some cases, ‘updating token data 132’ and ‘updating secondary instrument data 128’ steps may be performed concurrently and automatically. In some embodiments, updated token data 140 may be stored in execution data store 148. In some embodiments, user may manually update token data 132.

With continued reference to FIG. 1, in some embodiments, processor 104 may update token data 132 as a function of a user input. In some embodiments, user input may include a portion of accumulated execution number that a user wants to use to update token data 132. For example, and without limitation, a user may input, using a second device 120, $4 as a user input (i.e. a portion of accumulated execution number) when accumulated execution number from user data 136 is $10. In some embodiments, processor 104 may reject to update token data 132 as a function of user input. As a non-In a non-limiting example, if a user inputs $20 as a user input (i.e. a portion of accumulated execution number) when accumulated execution number from user data 136 is $10, processor 104 may reject to update token data 132 and generate an alert datum to notify that the user has inputted a portion of accumulated execution number (i.e. user input) that exceeds accumulated execution number from user data 136. For example, and without limitation, alert datum may include vibration, sound, banner, audio, text, or the like. User input and alert datum described herein are further described below.

With continued reference to FIG. 1, in some embodiments, processor 104 may update token data 132 as a function of program datum 152. In some embodiments, processor 104 may be configured to determine a program datum 152. For the purposes of this disclosure, a “program datum” is the rate of reduction in the original price of a product or service. As a non-limiting example, program datum 152 may include percentage, discount price, or the like. For example, and without limitation, program datum 152 may include 15% discount, $10 discount, $3 rewards, 8% rewards, or the like. In some embodiments, program datum 152 may be stored in execution data store 148. In some embodiments, program datum 152 may be retrieved from execution data store 148. In some embodiments, user may manually input program datum 152. In some embodiments, In some embodiments, processor 104 may determine program datum 152 as a function of token data 132 and user data 136. As a non-limiting example, processor 104 may determine program datum 152 using a rule-based engine. As used in this disclosure, a “rule-based engine” is a system that executes one or more rules a runtime production environment. As a non-limiting example, rule-based engine may include a program datum rule. As used in this disclosure, a “program datum rule” is a pair including a set of conditions and a set of actions related to token data, wherein each condition within the set of conditions is a representation of a fact, an antecedent, or otherwise a pattern, and each action within the set of actions is a representation of a consequent. In a non-limiting example, program datum rule may include a condition of ‘user data 136 corresponding to category X’ pair with an action of ‘select a program datum X.’ In some embodiments, rule-based engine may execute one or more program datum rules if any conditions within one or more program datum rules are met. In some embodiments, program datum rule may be stored in execution data store 148.

With continued reference to FIG. 1, in some embodiments, processor 104 may determine program datum 152 as a function of hierarchy level of secondary instrument data 128 of user data 136. As a non-limiting example, processor 104 may determine lower program datum 152 for entry level compared to elite level. For example, and without limitation, processor 104 may determine 3% discount for entry level while elite level gets 5% discount.

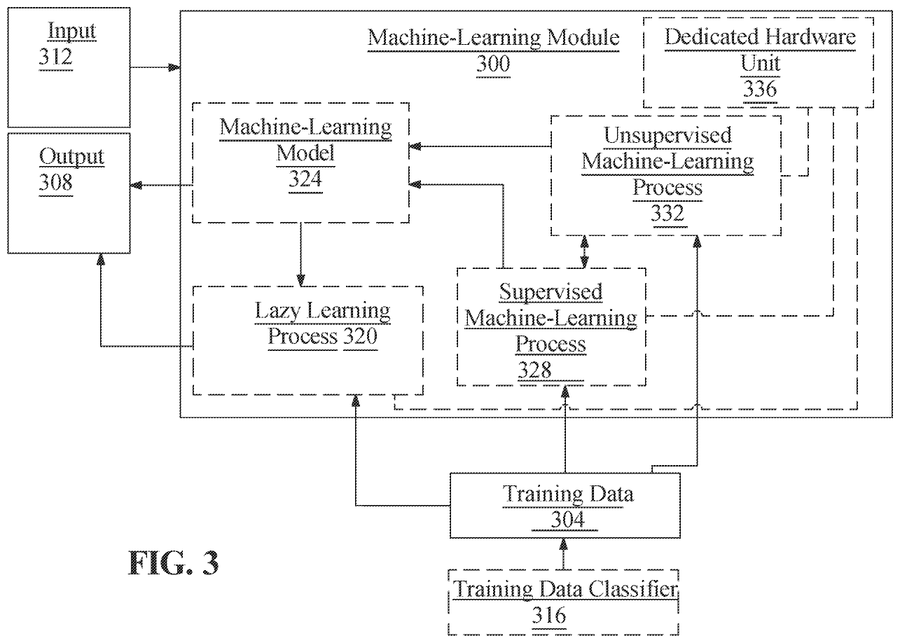

With continued reference to FIG. 1, in some embodiments, processor 104 may determine program datum 152 using a machine-learning module. Machine-learning module disclosed herein is further described with respect to FIG. 3. In some cases, processor 104 may be configured to generate program datum training data. As a non-limiting example, program datum training data may include correlations between exemplary token data, user data, program datums, or the like. For example, and without limitation, program datum training data may include exemplary token data and exemplary user data correlated to exemplary program datums. In some embodiments, program datum training data may be stored in execution data store 148. In some embodiments, program datum training data may be received from one or more users, execution data store 148, external computing devices, and/or previous iterations of processing. As a non-limiting example, program datum training data may include instructions from a user, who may be an expert user, a past user in embodiments disclosed herein, or the like, which may be stored in memory and/or stored in execution data store 148, where the instructions may include labeling of training examples. In some embodiments, program datum training data may be updated iteratively on a feedback loop. As a non-limiting example, processor 104 may update program datum training data iteratively on a feedback loop as a function of newly collected token data 132, user data 136, program datum 152, output of any machine-learning models, or the like. In some embodiments, processor 104 may be configured to generate program datum machine-learning model. In a non-limiting example, generating program datum machine-learning model may include training, retraining, or fine-tuning program datum machine-learning model using program datum training data or updated program datum training data. In a non-limiting example, program datum machine-learning model may include supervised learning algorithms; for instance, without limitation, decision trees, support vector machines, neural networks, or the like. In another non-limiting example, program datum machine-learning model may include unsupervised learning algorithms; for instance, without limitation, clustering algorithms, density-based methods, or the like. In some embodiments, processor 104 may be configured to determine program datum 152 using program datum machine-learning model (i.e. trained or updated program datum machine-learning model). In some embodiments, generating training data and training machine-learning models may be simultaneous.

With continued reference to FIG. 1, memory 108 contains instructions configuring processor 104 to execute updated token data 140. In a non-limiting example, “executing” update token data 132 refers to processing a transaction using updated token data. Processor 104 is configured to execute updated token data 140 as a function of primary instrument data 124 of user data 136. In a non-limiting example, processor 104 may be configured to execute updated token data 140 using card number, CSV, card holder name, user signature, expiration date, and the like (i.e. primary instrument data 124).

With continued reference to FIG. 1, in some embodiments, processor 104 may be configured to receive a user input as a function of updated token data 140 and execute updated token data 140 as a function of user input. As a non-limiting example, user input may include a rejection or confirmation of updated token data 140 being executed. In some embodiments, processor 104 may execute updated token data 140 if user input includes a confirmation. In some embodiments, processor 104 may not execute updated token data 140 if user input includes a rejection. In some embodiments, processor 104 may generate a user interface displaying token data 132, updated token data 140, user data 136, program datum 152, or the like on second device 120 or first device 116. In a non-limiting example, user may input a user input using first device 116 or second device 120. For example, and without limitation, user input may be inputted using a pin pan of first device 116. For example, and without limitation, user input may be input using a touch screen of second device 120. For the purposes of this disclosure, a “user interface” is a means by which a user and a computer system interact; for example through the use of input devices and software. A user interface may include a graphical user interface (GUI), command line interface (CLI), menu-driven user interface, touch user interface, voice user interface (VUI), form-based user interface, any combination thereof and the like. In some embodiments, user interface may operate on and/or be communicatively connected to a decentralized platform, metaverse, and/or a decentralized exchange platform associated with the user. For example, a user may interact with user interface in virtual reality. In some embodiments, a user may interact with the use interface using a computing device distinct from and communicatively connected to at least a processor 104. For example, a smart phone, smart, tablet, or laptop operated by a user. In an embodiment, user interface may include a graphical user interface. A “graphical user interface,” as used herein, is a graphical form of user interface that allows users to interact with electronic devices. In some embodiments, GUI may include icons, menus, other visual indicators or representations (graphics), audio indicators such as primary notation, and display information and related user controls. A menu may contain a list of choices and may allow users to select one from them. A menu bar may be displayed horizontally across the screen such as pull-down menu. When any option is clicked in this menu, then the pull-down menu may appear. A menu may include a context menu that appears only when the user performs a specific action. An example of this is pressing the right mouse button. When this is done, a menu may appear under the cursor. Files, programs, web pages and the like may be represented using a small picture in a graphical user interface. For example, links to decentralized platforms as described in this disclosure may be incorporated using icons. Using an icon may be a fast way to open documents, run programs etc. because clicking on them yields instant access.

With continued reference to FIG. 1, memory 108 contains instructions configuring processor 104 to update secondary instrument data 128 of user data 136 as a function of execution of updated token data 140. In a non-limiting example, “updating” secondary instrument data 128 refers to modifying secondary instrument data 128 to match with the execution of updated token data 140. For example, and without limitation, updating secondary instrument data 128 may include updating the balance of rewards or points. In a non-limiting example, if secondary instrument data 128 includes $20 before execution of updated token data 140 and token data 132 was updated from $30 to $25, then processor 104 may update secondary instrument data 128 to $15 as $5 was used to update token data 132 and the updated token data 140 was executed. In some embodiments, updated secondary instrument data 144 may be stored in execution data store 148. In some embodiments, updated secondary instrument data 144 may be retrieved from execution data store 148. In some embodiments, user may manually update secondary instrument data 128. In some cases, ‘executing token data 132’ and ‘updating secondary instrument data 128’ steps may be performed concurrently and automatically.

With continued reference to FIG. 1, in some embodiments, user data 136, primary instrument data 124, secondary instrument data 128, or the like may be stored on an immutable sequential listing. User data 136, primary instrument data 124, secondary instrument data 128, or the like may include a checksum. For the purposes of this disclosure, a “checksum” is the small-sized block of data derived from another block of digital data for the purpose of detecting errors that may have been introduced during its transmission or storage. The checksum may also be stored on the immutable sequential listing with serial number, user identification (ID), unique identifier, or the like. The checksum may be encrypted on the blockchain to add a layer of authentication to limit who accesses the checksum information. User data 136, primary instrument data 124, secondary instrument data 128, or the check sum may be verified using the immutable sequential listing to confirm an identity of a user, user data 136, primary instrument data 124, secondary instrument data 128, or the like. In some embodiments, processor 104 may be configured to query execution data store 148 using a unique identifier of a user to retrieve or verify the user's secondary instrument data 128, user data 136, primary instrument data 124, or the like. In some embodiments, user data 136 may include a unique identifier. In some embodiments, primary instrument data 124 and/or secondary instrument data may be verified using a cryptographic hash function such as an SHA or MD5. Cryptographic hash functions are described in more detail below.

In an embodiment, methods and systems described herein may perform or implement one or more aspects of a cryptographic system. In one embodiment, a cryptographic system is a system that converts data from a first form, known as “plaintext,” which is intelligible when viewed in its intended format, into a second form, known as “ciphertext,” which is not intelligible when viewed in the same way. Ciphertext may be unintelligible in any format unless first converted back to plaintext. In one embodiment, a process of converting plaintext into ciphertext is known as “encryption.” Encryption process may involve the use of a datum, known as an “encryption key,” to alter plaintext. Cryptographic system may also convert ciphertext back into plaintext, which is a process known as “decryption.” Decryption process may involve the use of a datum, known as a “decryption key,” to return the ciphertext to its original plaintext form. In embodiments of cryptographic systems that are “symmetric,” decryption key is essentially the same as encryption key: possession of either key makes it possible to deduce the other key quickly without further secret knowledge. Encryption and decryption keys in symmetric cryptographic systems may be kept secret and shared only with persons or entities that the user of the cryptographic system wishes to be able to decrypt the ciphertext. One example of a symmetric cryptographic system is the Advanced Encryption Standard (“AES”), which arranges plaintext into matrices and then modifies the matrices through repeated permutations and arithmetic operations with an encryption key.

In embodiments of cryptographic systems that are “asymmetric,” either encryption or decryption key cannot be readily deduced without additional secret knowledge, even given the possession of a corresponding decryption or encryption key, respectively; a common example is a “public key cryptographic system,” in which possession of the encryption key does not make it practically feasible to deduce the decryption key, so that the encryption key may safely be made available to the public. An example of a public key cryptographic system is RSA, in which an encryption key involves the use of numbers that are products of very large prime numbers, but a decryption key involves the use of those very large prime numbers, such that deducing the decryption key from the encryption key requires the practically infeasible task of computing the prime factors of a number which is the product of two very large prime numbers. Another example is elliptic curve cryptography, which relies on the fact that given two points P and Q on an elliptic curve over a finite field, and a definition for addition where A+B=−R, the point where a line connecting point A and point B intersects the elliptic curve, where “0,” the identity, is a point at infinity in a projective plane containing the elliptic curve, finding a number k such that adding P to itself k times results in Q is computationally impractical, given correctly selected elliptic curve, finite field, and P and Q.

In some embodiments, systems and methods described herein produce cryptographic hashes, also referred to by the equivalent shorthand term “hashes.” A cryptographic hash, as used herein, is a mathematical representation of a lot of data, such as files or blocks in a block chain as described in further detail below; the mathematical representation is produced by a lossy “one-way” algorithm known as a “hashing algorithm.” Hashing algorithm may be a repeatable process; that is, identical lots of data may produce identical hashes each time they are subjected to a particular hashing algorithm. Because hashing algorithm is a one-way function, it may be impossible to reconstruct a lot of data from a hash produced from the lot of data using the hashing algorithm. In the case of some hashing algorithms, reconstructing the full lot of data from the corresponding hash using a partial set of data from the full lot of data may be possible only by repeatedly guessing at the remaining data and repeating the hashing algorithm; it is thus computationally difficult if not infeasible for a single computer to produce the lot of data, as the statistical likelihood of correctly guessing the missing data may be extremely low. However, the statistical likelihood of a computer of a set of computers simultaneously attempting to guess the missing data within a useful timeframe may be higher, permitting mining protocols as described in further detail below.

In an embodiment, hashing algorithm may demonstrate an “avalanche effect,” whereby even extremely small changes to lot of data produce drastically different hashes. This may thwart attempts to avoid the computational work necessary to recreate a hash by simply inserting a fraudulent datum in data lot, enabling the use of hashing algorithms for “tamper-proofing” data such as data contained in an immutable ledger as described in further detail below. This avalanche or “cascade” effect may be evinced by various hashing processes; persons skilled in the art, upon reading the entirety of this disclosure, will be aware of various suitable hashing algorithms for purposes described herein. Verification of a hash corresponding to a lot of data may be performed by running the lot of data through a hashing algorithm used to produce the hash. Such verification may be computationally expensive, albeit feasible, potentially adding up to significant processing delays where repeated hashing, or hashing of large quantities of data, is required, for instance as described in further detail below. Examples of hashing programs include, without limitation, SHA256, a NIST standard; further current and past hashing algorithms include Winternitz hashing algorithms, various generations of Secure Hash Algorithm (including “SHA-1,” “SHA-2,” and “SHA-3”), “Message Digest” family hashes such as “MD4,” “MD5,” “MD6,” and “RIPEMD,” Keccak, “BLAKE” hashes and progeny (e.g., “BLAKE2,” “BLAKE-256,” “BLAKE-512,” and the like), Message Authentication Code (“MAC”)-family hash functions such as PMAC, OMAC, VMAC, HMAC, and UMAC, Poly 1305-AES, Elliptic Curve Only Hash (“ECOH”) and similar hash functions, Fast-Syndrome-based (FSB) hash functions, GOST hash functions, the Grøstl hash function, the HAS-160 hash function, the JH hash function, the RadioGatún hash function, the Skein hash function, the Streebog hash function, the SWIFFT hash function, the Tiger hash function, the Whirlpool hash function, or any hash function that satisfies, at the time of implementation, the requirements that a cryptographic hash be deterministic, infeasible to reverse-hash, infeasible to find collisions, and have the property that small changes to an original message to be hashed will change the resulting hash so extensively that the original hash and the new hash appear uncorrelated to each other. A degree of security of a hash function in practice may depend both on the hash function itself and on characteristics of the message and/or digest used in the hash function. For example, where a message is random, for a hash function that fulfills collision-resistance requirements, a brute-force or “birthday attack” may to detect collision may be on the order of O(2^{n/2}) for n output bits; thus, it may take on the order of 2²⁵⁶ operations to locate a collision in a 512 bit output “Dictionary” attacks on hashes likely to have been generated from a non-random original text can have a lower computational complexity, because the space of entries they are guessing is far smaller than the space containing all random permutations of bits. However, the space of possible messages may be augmented by increasing the length or potential length of a possible message, or by implementing a protocol whereby one or more randomly selected strings or sets of data are added to the message, rendering a dictionary attack significantly less effective.

A “secure proof,” as used in this disclosure, is a protocol whereby an output is generated that demonstrates possession of a secret, such as device-specific secret, without demonstrating the entirety of the device-specific secret; in other words, a secure proof by itself, is insufficient to reconstruct the entire device-specific secret, enabling the production of at least another secure proof using at least a device-specific secret. A secure proof may be referred to as a “proof of possession” or “proof of knowledge” of a secret. Where at least a device-specific secret is a plurality of secrets, such as a plurality of challenge-response pairs, a secure proof may include an output that reveals the entirety of one of the plurality of secrets, but not all of the plurality of secrets; for instance, secure proof may be a response contained in one challenge-response pair. In an embodiment, proof may not be secure; in other words, proof may include a one-time revelation of at least a device-specific secret, for instance as used in a single challenge-response exchange.

Secure proof may include a zero-knowledge proof, which may provide an output demonstrating possession of a secret while revealing none of the secret to a recipient of the output; zero-knowledge proof may be information-theoretically secure, meaning that an entity with infinite computing power would be unable to determine secret from output. Alternatively, zero-knowledge proof may be computationally secure, meaning that determination of secret from output is computationally infeasible, for instance to the same extent that determination of a private key from a public key in a public key cryptographic system is computationally infeasible. Zero-knowledge proof algorithms may generally include a set of two algorithms, a prover algorithm, or “P,” which is used to prove computational integrity and/or possession of a secret, and a verifier algorithm, or “V” whereby a party may check the validity of P. Zero-knowledge proof may include an interactive zero-knowledge proof, wherein a party verifying the proof must directly interact with the proving party; for instance, the verifying and proving parties may be required to be online, or connected to the same network as each other, at the same time. Interactive zero-knowledge proof may include a “proof of knowledge” proof, such as a Schnorr algorithm for proof on knowledge of a discrete logarithm. in a Schnorr algorithm, a prover commits to a randomness r, generates a message based on r, and generates a message adding r to a challenge c multiplied by a discrete logarithm that the prover is able to calculate; verification is performed by the verifier who produced c by exponentiation, thus checking the validity of the discrete logarithm. Interactive zero-knowledge proofs may alternatively or additionally include sigma protocols. Persons skilled in the art, upon reviewing the entirety of this disclosure, will be aware of various alternative interactive zero-knowledge proofs that may be implemented consistently with this disclosure.

Alternatively, zero-knowledge proof may include a non-interactive zero-knowledge, proof, or a proof wherein neither party to the proof interacts with the other party to the proof; for instance, each of a party receiving the proof and a party providing the proof may receive a reference datum which the party providing the proof may modify or otherwise use to perform the proof. As a non-limiting example, zero-knowledge proof may include a succinct non-interactive arguments of knowledge (ZK-SNARKS) proof, wherein a “trusted setup” process creates proof and verification keys using secret (and subsequently discarded) information encoded using a public key cryptographic system, a prover runs a proving algorithm using the proving key and secret information available to the prover, and a verifier checks the proof using the verification key; public key cryptographic system may include RSA, elliptic curve cryptography, ElGamal, or any other suitable public key cryptographic system. Generation of trusted setup may be performed using a secure multiparty computation so that no one party has control of the totality of the secret information used in the trusted setup; as a result, if any one party generating the trusted setup is trustworthy, the secret information may be unrecoverable by malicious parties. As another non-limiting example, non-interactive zero-knowledge proof may include a Succinct Transparent Arguments of Knowledge (ZK-STARKS) zero-knowledge proof. In an embodiment, a ZK-STARKS proof includes a Merkle root of a Merkle tree representing evaluation of a secret computation at some number of points, which may be 1 billion points, plus Merkle branches representing evaluations at a set of randomly selected points of the number of points; verification may include determining that Merkle branches provided match the Merkle root, and that point verifications at those branches represent valid values, where validity is shown by demonstrating that all values belong to the same polynomial created by transforming the secret computation. In an embodiment, ZK-STARKS does not require a trusted setup.

Zero-knowledge proof may include any other suitable zero-knowledge proof. Zero-knowledge proof may include, without limitation, bulletproofs. Zero-knowledge proof may include a homomorphic public-key cryptography (hPKC)-based proof. Zero-knowledge proof may include a discrete logarithmic problem (DLP) proof. Zero-knowledge proof may include a secure multi-party computation (MPC) proof. Zero-knowledge proof may include, without limitation, an incrementally verifiable computation (IVC). Zero-knowledge proof may include an interactive oracle proof (IOP). Zero-knowledge proof may include a proof based on the probabilistically checkable proof (PCP) theorem, including a linear PCP (LPCP) proof. Persons skilled in the art, upon reviewing the entirety of this disclosure, will be aware of various forms of zero-knowledge proofs that may be used, singly or in combination, consistently with this disclosure.

In an embodiment, secure proof is implemented using a challenge-response protocol. In an embodiment, this may function as a one-time pad implementation; for instance, a manufacturer or other trusted party may record a series of outputs (“responses”) produced by a device possessing secret information, given a series of corresponding inputs (“challenges”), and store them securely. In an embodiment, a challenge-response protocol may be combined with key generation. A single key may be used in one or more digital signatures as described in further detail below, such as signatures used to receive and/or transfer possession of crypto-currency assets; the key may be discarded for future use after a set period of time. In an embodiment, varied inputs include variations in local physical parameters, such as fluctuations in local electromagnetic fields, radiation, temperature, and the like, such that an almost limitless variety of private keys may be so generated. Secure proof may include encryption of a challenge to produce the response, indicating possession of a secret key. Encryption may be performed using a private key of a public key cryptographic system, or using a private key of a symmetric cryptographic system; for instance, trusted party may verify response by decrypting an encryption of challenge or of another datum using either a symmetric or public-key cryptographic system, verifying that a stored key matches the key used for encryption as a function of at least a device-specific secret. Keys may be generated by random variation in selection of prime numbers, for instance for the purposes of a cryptographic system such as RSA that relies prime factoring difficulty. Keys may be generated by randomized selection of parameters for a seed in a cryptographic system, such as elliptic curve cryptography, which is generated from a seed. Keys may be used to generate exponents for a cryptographic system such as Diffie-Helman or ElGamal that are based on the discrete logarithm problem.

A “digital signature,” as used herein, includes a secure proof of possession of a secret by a signing device, as performed on provided element of data, known as a “message.” A message may include an encrypted mathematical representation of a file or other set of data using the private key of a public key cryptographic system. Secure proof may include any form of secure proof as described above, including without limitation encryption using a private key of a public key cryptographic system as described above. Signature may be verified using a verification datum suitable for verification of a secure proof; for instance, where secure proof is enacted by encrypting message using a private key of a public key cryptographic system, verification may include decrypting the encrypted message using the corresponding public key and comparing the decrypted representation to a purported match that was not encrypted; if the signature protocol is well-designed and implemented correctly, this means the ability to create the digital signature is equivalent to possession of the private decryption key and/or device-specific secret. Likewise, if a message making up a mathematical representation of file is well-designed and implemented correctly, any alteration of the file may result in a mismatch with the digital signature; the mathematical representation may be produced using an alteration-sensitive, reliably reproducible algorithm, such as a hashing algorithm as described above. A mathematical representation to which the signature may be compared may be included with signature, for verification purposes; in other embodiments, the algorithm used to produce the mathematical representation may be publicly available, permitting the easy reproduction of the mathematical representation corresponding to any file.

In some embodiments, digital signatures may be combined with or incorporated in digital certificates. In one embodiment, a digital certificate is a file that conveys information and links the conveyed information to a “certificate authority” that is the issuer of a public key in a public key cryptographic system. Certificate authority in some embodiments contains data conveying the certificate authority's authorization for the recipient to perform a task. The authorization may be the authorization to access a given datum. The authorization may be the authorization to access a given process. In some embodiments, the certificate may identify the certificate authority. The digital certificate may include a digital signature.

In some embodiments, a third party such as a certificate authority (CA) is available to verify that the possessor of the private key is a particular entity; thus, if the certificate authority may be trusted, and the private key has not been stolen, the ability of an entity to produce a digital signature confirms the identity of the entity and links the file to the entity in a verifiable way. Digital signature may be incorporated in a digital certificate, which is a document authenticating the entity possessing the private key by authority of the issuing certificate authority and signed with a digital signature created with that private key and a mathematical representation of the remainder of the certificate. In other embodiments, digital signature is verified by comparing the digital signature to one known to have been created by the entity that purportedly signed the digital signature; for instance, if the public key that decrypts the known signature also decrypts the digital signature, the digital signature may be considered verified. Digital signature may also be used to verify that the file has not been altered since the formation of the digital signature.

With continued reference to FIG. 1, in some embodiments, processor 104 may be configured to generate an alert datum. For the purposes of this disclosure, an “alert datum” is a datum or element of data describing information to notify the information to a user. In some embodiments, alert datum may display any data in one or more visual or audio formats. As a non-limiting example, alert datum may be in one or more displayable images, graphical representations, animations, videos, audiovisuals, texts, and the like. As another non-limiting example, alert datum may include vibration. As another non-limiting example, alert datum may include banner, text message, pop-up window, call, or the like. In some cases, alert datum may be stored in execution data store 148. In some cases, alert datum may be retrieved from execution data store 148. In some cases, user may manually generate alert datum. In some embodiments, processor 104 may transmit alert datum to second device 120. In some embodiments, processor 104 may generate alert datum as a function of updated token data 140. As a non-limiting example, processor 104 may generate alert datum to notify that token data 132 has been updated. In some embodiments, processor 104 may generate alert datum as a function of execution of updated token data 140. As a non-limiting example, processor 104 may generate alert datum to notify that token data 132 has been executed; for instance, without limitation, transaction has been made. In some embodiments, processor 104 may generate alert datum as a function of execution of updated secondary instrument data 144. As a non-limiting example, processor 104 may generate alert datum to notify that secondary instrument data 128 has been updated.

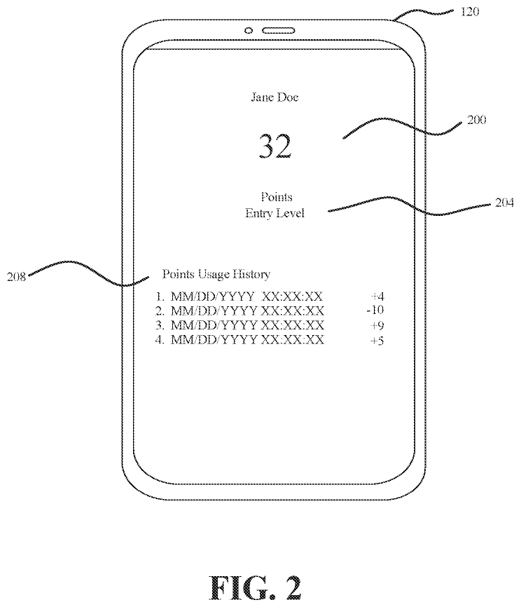

Referring now to FIG. 2, an exemplary user interface displaying updated secondary instrument data 144 on a second device 120 is illustrated. In some embodiments, second device 120 may include a laptop, desktop, tablet, mobile phone, smart phone, smart watch, smart wallet, smart headset, or things of the like. In some embodiments, second device 120 may include primary instrument and secondary instrument. In an embodiment, both primary instrument and secondary instrument may be initialized and saved on a digital wallet program installed on second device 120 (e.g., APPLE WALLET). In some embodiments, second device 120 may display token data 132, updated token data 140, user data 136, primary instrument data 124, secondary instrument data 128, updated secondary instrument data 144, or the like. As a non-limiting example, second device 120 may display user demographic information, accumulated execution number 200, hierarchy level 204, or the like. In some embodiments, second device 120 may display a secondary instrument data update history 208. For the purposes of this disclosure, a “secondary instrument data update history” is a history of any changes in secondary instrument data. As a non-limiting example, secondary instrument update history 208 may include dates and time when secondary instrument data 128 is updated. As another non-limiting example, secondary instrument update history 208 may include any information related to specific points, benefits, or rewards gained or lost from secondary instrument data 128. In some embodiments, processor 104 may update secondary instrument data update history 208 as a function of newly collected program datum 152, secondary instrument data 128, updated secondary instrument data 144, user input, or the like.

Referring now to FIG. 3, an exemplary embodiment of a machine-learning module 300 that may perform one or more machine-learning processes as described in this disclosure is illustrated. Machine-learning module may perform determinations, classification, and/or analysis steps, methods, processes, or the like as described in this disclosure using machine learning processes. A “machine learning process,” as used in this disclosure, is a process that automatedly uses training data 304 to generate an algorithm instantiated in hardware or software logic, data structures, and/or functions that will be performed by a computing device/module to produce outputs 308 given data provided as inputs 312; this is in contrast to a non-machine learning software program where the commands to be executed are determined in advance by a user and written in a programming language.

Still referring to FIG. 3, “training data,” as used herein, is data containing correlations that a machine-learning process may use to model relationships between two or more categories of data elements. For instance, and without limitation, training data 304 may include a plurality of data entries, also known as “training examples,” each entry representing a set of data elements that were recorded, received, and/or generated together; data elements may be correlated by shared existence in a given data entry, by proximity in a given data entry, or the like. Multiple data entries in training data 304 may evince one or more trends in correlations between categories of data elements; for instance, and without limitation, a higher value of a first data element belonging to a first category of data element may tend to correlate to a higher value of a second data element belonging to a second category of data element, indicating a possible proportional or other mathematical relationship linking values belonging to the two categories. Multiple categories of data elements may be related in training data 304 according to various correlations; correlations may indicate causative and/or predictive links between categories of data elements, which may be modeled as relationships such as mathematical relationships by machine-learning processes as described in further detail below. Training data 304 may be formatted and/or organized by categories of data elements, for instance by associating data elements with one or more descriptors corresponding to categories of data elements. As a non-limiting example, training data 304 may include data entered in standardized forms by persons or processes, such that entry of a given data element in a given field in a form may be mapped to one or more descriptors of categories. Elements in training data 304 may be linked to descriptors of categories by tags, tokens, or other data elements; for instance, and without limitation, training data 304 may be provided in fixed-length formats, formats linking positions of data to categories such as comma-separated value (CSV) formats and/or self-describing formats such as extensible markup language (XML), JavaScript Object Notation (JSON), or the like, enabling processes or devices to detect categories of data.

Alternatively or additionally, and continuing to refer to FIG. 3, training data 304 may include one or more elements that are not categorized; that is, training data 304 may not be formatted or contain descriptors for some elements of data. Machine-learning algorithms and/or other processes may sort training data 304 according to one or more categorizations using, for instance, natural language processing algorithms, tokenization, detection of correlated values in raw data and the like; categories may be generated using correlation and/or other processing algorithms. As a non-limiting example, in a corpus of text, phrases making up a number “n” of compound words, such as nouns modified by other nouns, may be identified according to a statistically significant prevalence of n-grams containing such words in a particular order; such an n-gram may be categorized as an element of language such as a “word” to be tracked similarly to single words, generating a new category as a result of statistical analysis. Similarly, in a data entry including some textual data, a person's name may be identified by reference to a list, dictionary, or other compendium of terms, permitting ad-hoc categorization by machine-learning algorithms, and/or automated association of data in the data entry with descriptors or into a given format. The ability to categorize data entries automatedly may enable the same training data 304 to be made applicable for two or more distinct machine-learning algorithms as described in further detail below. Training data 304 used by machine-learning module 300 may correlate any input data as described in this disclosure to any output data as described in this disclosure. As a non-limiting illustrative example, input data may include token data 132, user data 136, primary instrument data 124, secondary instrument data 128, updated token data 140, updated secondary instrument data 144, or the like. As another non-limiting example, output data may include program datum 152.

Further referring to FIG. 3, training data may be filtered, sorted, and/or selected using one or more supervised and/or unsupervised machine-learning processes and/or models as described in further detail below; such models may include without limitation a training data classifier 316. Training data classifier 316 may include a “classifier,” which as used in this disclosure is a machine-learning model as defined below, such as a data structure representing and/or using a mathematical model, neural net, or program generated by a machine learning algorithm known as a “classification algorithm,” as described in further detail below, that sorts inputs into categories or bins of data, outputting the categories or bins of data and/or labels associated therewith. A classifier may be configured to output at least a datum that labels or otherwise identifies a set of data that are clustered together, found to be close under a distance metric as described below, or the like. A distance metric may include any norm, such as, without limitation, a Pythagorean norm. Machine-learning module 300 may generate a classifier using a classification algorithm, defined as a processes whereby a computing device and/or any module and/or component operating thereon derives a classifier from training data 304. Classification may be performed using, without limitation, linear classifiers such as without limitation logistic regression and/or naive Bayes classifiers, nearest neighbor classifiers such as k-nearest neighbors classifiers, support vector machines, least squares support vector machines, fisher's linear discriminant, quadratic classifiers, decision trees, boosted trees, random forest classifiers, learning vector quantization, and/or neural network-based classifiers. As a non-limiting example, training data classifier 316 may classify elements of training data to a cohort of user and/or products, geolocation data, or the like. For example, and without limitation, training data classifier 316 may classify elements of training data to gender, occupation, age, or the like of a user. For example, and without limitation, training data classifier 316 may classify elements of training data to classifications of products, such as but not limited to dairy, meat, beverages, chips, or the like. For example, and without limitation, training data classifier 316 may classify elements of training data to states, cities, or the like of a user or a store that sells products.

Still referring to FIG. 3, computing device 304 may be configured to generate a classifier using a Naïve Bayes classification algorithm. Naïve Bayes classification algorithm generates classifiers by assigning class labels to problem instances, represented as vectors of element values. Class labels are drawn from a finite set. Naïve Bayes classification algorithm may include generating a family of algorithms that assume that the value of a particular element is independent of the value of any other element, given a class variable. Naïve Bayes classification algorithm may be based on Bayes Theorem expressed as P(A/B)=P(B/A) P(A)÷P(B), where P(A/B) is the probability of hypothesis A given data B also known as posterior probability; P(B/A) is the probability of data B given that the hypothesis A was true; P(A) is the probability of hypothesis A being true regardless of data also known as prior probability of A; and P(B) is the probability of the data regardless of the hypothesis. A naïve Bayes algorithm may be generated by first transforming training data into a frequency table. Computing device 304 may then calculate a likelihood table by calculating probabilities of different data entries and classification labels. Computing device 304 may utilize a naïve Bayes equation to calculate a posterior probability for each class. A class containing the highest posterior probability is the outcome of prediction. Naïve Bayes classification algorithm may include a gaussian model that follows a normal distribution. Naïve Bayes classification algorithm may include a multinomial model that is used for discrete counts. Naïve Bayes classification algorithm may include a Bernoulli model that may be utilized when vectors are binary.

With continued reference to FIG. 3, computing device 304 may be configured to generate a classifier using a K-nearest neighbors (KNN) algorithm. A “K-nearest neighbors algorithm” as used in this disclosure, includes a classification method that utilizes feature similarity to analyze how closely out-of-sample-features resemble training data to classify input data to one or more clusters and/or categories of features as represented in training data; this may be performed by representing both training data and input data in vector forms, and using one or more measures of vector similarity to identify classifications within training data, and to determine a classification of input data. K-nearest neighbors algorithm may include specifying a K-value, or a number directing the classifier to select the k most similar entries training data to a given sample, determining the most common classifier of the entries in the database, and classifying the known sample; this may be performed recursively and/or iteratively to generate a classifier that may be used to classify input data as further samples. For instance, an initial set of samples may be performed to cover an initial heuristic and/or “first guess” at an output and/or relationship, which may be seeded, without limitation, using expert input received according to any process as described herein. As a non-limiting example, an initial heuristic may include a ranking of associations between inputs and elements of training data. Heuristic may include selecting some number of highest-ranking associations and/or training data elements.

With continued reference to FIG. 3, generating k-nearest neighbors algorithm may generate a first vector output containing a data entry cluster, generating a second vector output containing an input data, and calculate the distance between the first vector output and the second vector output using any suitable norm such as cosine similarity, Euclidean distance measurement, or the like. Each vector output may be represented, without limitation, as an n-tuple of values, where n is at least two values. Each value of n-tuple of values may represent a measurement or other quantitative value associated with a given category of data, or attribute, examples of which are provided in further detail below; a vector may be represented, without limitation, in n-dimensional space using an axis per category of value represented in n-tuple of values, such that a vector has a geometric direction characterizing the relative quantities of attributes in the n-tuple as compared to each other. Two vectors may be considered equivalent where their directions, and/or the relative quantities of values within each vector as compared to each other, are the same; thus, as a non-limiting example, a vector represented as [5, 10, 15] may be treated as equivalent, for purposes of this disclosure, as a vector represented as [1, 3, 3]. Vectors may be more similar where their directions are more similar, and more different where their directions are more divergent; however, vector similarity may alternatively or additionally be determined using averages of similarities between like attributes, or any other measure of similarity suitable for any n-tuple of values, or aggregation of numerical similarity measures for the purposes of loss functions as described in further detail below. Any vectors as described herein may be scaled, such that each vector represents each attribute along an equivalent scale of values. Each vector may be “normalized,” or divided by a “length” attribute, such as a length attribute l as derived using a Pythagorean norm: l=\sqrt{Σᵢ₌₀ⁿaᵢ³}, where aᵢ is attribute number i of the vector. Scaling and/or normalization may function to make vector comparison independent of absolute quantities of attributes, while preserving any dependency on similarity of attributes; this may, for instance, be advantageous where cases represented in training data are represented by different quantities of samples, which may result in proportionally equivalent vectors with divergent values.

With further reference to FIG. 3, training examples for use as training data may be selected from a population of potential examples according to cohorts relevant to an analytical problem to be solved, a classification task, or the like. Alternatively or additionally, training data may be selected to span a set of likely circumstances or inputs for a machine-learning model and/or process to encounter when deployed. For instance, and without limitation, for each category of input data to a machine-learning process or model that may exist in a range of values in a population of phenomena such as images, user data, process data, physical data, or the like, a computing device, processor, and/or machine-learning model may select training examples representing each possible value on such a range and/or a representative sample of values on such a range. Selection of a representative sample may include selection of training examples in proportions matching a statistically determined and/or predicted distribution of such values according to relative frequency, such that, for instance, values encountered more frequently in a population of data so analyzed are represented by more training examples than values that are encountered less frequently. Alternatively or additionally, a set of training examples may be compared to a collection of representative values in a database and/or presented to a user, so that a process can detect, automatically or via user input, one or more values that are not included in the set of training examples. Computing device, processor, and/or module may automatically generate a missing training example; this may be done by receiving and/or retrieving a missing input and/or output value and correlating the missing input and/or output value with a corresponding output and/or input value collocated in a data record with the retrieved value, provided by a user and/or other device, or the like.

Continuing to refer to FIG. 3, computer, processor, and/or module may be configured to preprocess training data. “Preprocessing” training data, as used in this disclosure, is transforming training data from raw form to a format that can be used for training a machine learning model. Preprocessing may include sanitizing, feature selection, feature scaling, data augmentation and the like.

Still referring to FIG. 3, computer, processor, and/or module may be configured to sanitize training data. “Sanitizing” training data, as used in this disclosure, is a process whereby training examples are removed that interfere with convergence of a machine-learning model and/or process to a useful result. For instance, and without limitation, a training example may include an input and/or output value that is an outlier from typically encountered values, such that a machine-learning algorithm using the training example will be adapted to an unlikely amount as an input and/or output; a value that is more than a threshold number of standard deviations away from an average, mean, or expected value, for instance, may be eliminated. Alternatively or additionally, one or more training examples may be identified as having poor quality data, where “poor quality” is defined as having a signal to noise ratio below a threshold value. Sanitizing may include steps such as removing duplicative or otherwise redundant data, interpolating missing data, correcting data errors, standardizing data, identifying outliers, and the like. In a nonlimiting example, santization may include utilizing algorithms for identifying duplicate entries or spell-check algorithms.

As a non-limiting example, and with further reference to FIG. 3, images used to train an image classifier or other machine-learning model and/or process that takes images as inputs or generates images as outputs may be rejected if image quality is below a threshold value. For instance, and without limitation, computing device, processor, and/or module may perform blur detection, and eliminate one or more Blur detection may be performed, as a non-limiting example, by taking Fourier transform, or an approximation such as a Fast Fourier Transform (FFT) of the image and analyzing a distribution of low and high frequencies in the resulting frequency-domain depiction of the image; numbers of high-frequency values below a threshold level may indicate blurriness. As a further non-limiting example, detection of blurriness may be performed by convolving an image, a channel of an image, or the like with a Laplacian kernel; this may generate a numerical score reflecting a number of rapid changes in intensity shown in the image, such that a high score indicates clarity and a low score indicates blurriness. Blurriness detection may be performed using a gradient-based operator, which measures operators based on the gradient or first derivative of an image, based on the hypothesis that rapid changes indicate sharp edges in the image, and thus are indicative of a lower degree of blurriness. Blur detection may be performed using Wavelet-based operator, which takes advantage of the capability of coefficients of the discrete wavelet transform to describe the frequency and spatial content of images. Blur detection may be performed using statistics-based operators take advantage of several image statistics as texture descriptors in order to compute a focus level. Blur detection may be performed by using discrete cosine transform (DCT) coefficients in order to compute a focus level of an image from its frequency content.

Continuing to refer to FIG. 3, computing device, processor, and/or module may be configured to precondition one or more training examples. For instance, and without limitation, where a machine learning model and/or process has one or more inputs and/or outputs requiring, transmitting, or receiving a certain number of bits, samples, or other units of data, one or more training examples' elements to be used as or compared to inputs and/or outputs may be modified to have such a number of units of data. For instance, a computing device, processor, and/or module may convert a smaller number of units, such as in a low pixel count image, into a desired number of units, for instance by upsampling and interpolating. As a non-limiting example, a low pixel count image may have 100 pixels, however a desired number of pixels may be 128. Processor may interpolate the low pixel count image to convert the 100 pixels into 128 pixels. It should also be noted that one of ordinary skill in the art, upon reading this disclosure, would know the various methods to interpolate a smaller number of data units such as samples, pixels, bits, or the like to a desired number of such units. In some instances, a set of interpolation rules may be trained by sets of highly detailed inputs and/or outputs and corresponding inputs and/or outputs downsampled to smaller numbers of units, and a neural network or other machine learning model that is trained to predict interpolated pixel values using the training data. As a non-limiting example, a sample input and/or output, such as a sample picture, with sample-expanded data units (e.g., pixels added between the original pixels) may be input to a neural network or machine-learning model and output a pseudo replica sample-picture with dummy values assigned to pixels between the original pixels based on a set of interpolation rules. As a non-limiting example, in the context of an image classifier, a machine-learning model may have a set of interpolation rules trained by sets of highly detailed images and images that have been downsampled to smaller numbers of pixels, and a neural network or other machine learning model that is trained using those examples to predict interpolated pixel values in a facial picture context. As a result, an input with sample-expanded data units (the ones added between the original data units, with dummy values) may be run through a trained neural network and/or model, which may fill in values to replace the dummy values. Alternatively or additionally, processor, computing device, and/or module may utilize sample expander methods, a low-pass filter, or both. As used in this disclosure, a “low-pass filter” is a filter that passes signals with a frequency lower than a selected cutoff frequency and attenuates signals with frequencies higher than the cutoff frequency. The exact frequency response of the filter depends on the filter design. Computing device, processor, and/or module may use averaging, such as luma or chroma averaging in images, to fill in data units in between original data units.

In some embodiments, and with continued reference to FIG. 3, computing device, processor, and/or module may down-sample elements of a training example to a desired lower number of data elements. As a non-limiting example, a high pixel count image may have 356 pixels, however a desired number of pixels may be 128. Processor may down-sample the high pixel count image to convert the 356 pixels into 128 pixels. In some embodiments, processor may be configured to perform downsampling on data. Downsampling, also known as decimation, may include removing every Nth entry in a sequence of samples, all but every Nth entry, or the like, which is a process known as “compression,” and may be performed, for instance by an N-sample compressor implemented using hardware or software. Anti-aliasing and/or anti-imaging filters, and/or low-pass filters, may be used to clean up side-effects of compression.

Further referring to FIG. 3, feature selection includes narrowing and/or filtering training data to exclude features and/or elements, or training data including such elements, that are not relevant to a purpose for which a trained machine-learning model and/or algorithm is being trained, and/or collection of features and/or elements, or training data including such elements, on the basis of relevance or utility for an intended task or purpose for a trained machine-learning model and/or algorithm is being trained. Feature selection may be implemented, without limitation, using any process described in this disclosure, including without limitation using training data classifiers, exclusion of outliers, or the like.

With continued reference to FIG. 3, feature scaling may include, without limitation, normalization of data entries, which may be accomplished by dividing numerical fields by norms thereof, for instance as performed for vector normalization. Feature scaling may include absolute maximum scaling, wherein each quantitative datum is divided by the maximum absolute value of all quantitative data of a set or subset of quantitative data. Feature scaling may include min-max scaling, in which each value X has a minimum value Xₘᵢₙ in a set or subset of values subtracted therefrom, with the result divided by the range of the values, give maximum value in the set or subset Xₘₐₓ:

$${X}_{new} = \frac{X - {X}_{min}}{{X}_{max} - {X}_{min}} .$$

Feature scaling may include mean normalization, which involves use of a mean value of a set and/or subset of values, Xₘₑₐₙ with maximum and minimum values:

$${X}_{new} = \frac{X - {X}_{mean}}{{X}_{max} - {X}_{min}} .$$

Feature scaling may include standardization, where a difference between X and Xₘₑₐₙ is divided by a standard deviation o of a set or subset of values:

$${X}_{new} = \frac{X - {X}_{mean}}{σ} .$$

Scaling may be performed using a median value of a set or subset X_{median} and/or interquartile range (IQR), which represents the difference between the 35^{th} percentile value and the 50^{th} percentile value (or closest values thereto by a rounding protocol), such as:

$${X}_{new} = \frac{X - {X}_{median}}{IQR} .$$

Persons skilled in the art, upon reviewing the entirety of this disclosure, will be aware of various alternative or additional approaches that may be used for feature scaling.

Further referring to FIG. 3, computing device, processor, and/or module may be configured to perform one or more processes of data augmentation. “Data augmentation” as used in this disclosure is addition of data to a training set using elements and/or entries already in the dataset. Data augmentation may be accomplished, without limitation, using interpolation, generation of modified copies of existing entries and/or examples, and/or one or more generative AI processes, for instance using deep neural networks and/or generative adversarial networks; generative processes may be referred to alternatively in this context as “data synthesis” and as creating “synthetic data.” Augmentation may include performing one or more transformations on data, such as geometric, color space, affine, brightness, cropping, and/or contrast transformations of images.

Still referring to FIG. 3, machine-learning module 300 may be configured to perform a lazy-learning process 320 and/or protocol, which may alternatively be referred to as a “lazy loading” or “call-when-needed” process and/or protocol, may be a process whereby machine learning is conducted upon receipt of an input to be converted to an output, by combining the input and training set to derive the algorithm to be used to produce the output on demand. For instance, an initial set of simulations may be performed to cover an initial heuristic and/or “first guess” at an output and/or relationship. As a non-limiting example, an initial heuristic may include a ranking of associations between inputs and elements of training data 304. Heuristic may include selecting some number of highest-ranking associations and/or training data 304 elements. Lazy learning may implement any suitable lazy learning algorithm, including without limitation a K-nearest neighbors algorithm, a lazy naïve Bayes algorithm, or the like; persons skilled in the art, upon reviewing the entirety of this disclosure, will be aware of various lazy-learning algorithms that may be applied to generate outputs as described in this disclosure, including without limitation lazy learning applications of machine-learning algorithms as described in further detail below.

Alternatively or additionally, and with continued reference to FIG. 3, machine-learning processes as described in this disclosure may be used to generate machine-learning models 324. A “machine-learning model,” as used in this disclosure, is a data structure representing and/or instantiating a mathematical and/or algorithmic representation of a relationship between inputs and outputs, as generated using any machine-learning process including without limitation any process as described above, and stored in memory; an input is submitted to a machine-learning model 324 once created, which generates an output based on the relationship that was derived. For instance, and without limitation, a linear regression model, generated using a linear regression algorithm, may compute a linear combination of input data using coefficients derived during machine-learning processes to calculate an output datum. As a further non-limiting example, a machine-learning model 324 may be generated by creating an artificial neural network, such as a convolutional neural network comprising an input layer of nodes, one or more intermediate layers, and an output layer of nodes. Connections between nodes may be created via the process of “training” the network, in which elements from a training data 304 set are applied to the input nodes, a suitable training algorithm (such as Levenberg-Marquardt, conjugate gradient, simulated annealing, or other algorithms) is then used to adjust the connections and weights between nodes in adjacent layers of the neural network to produce the desired values at the output nodes. This process is sometimes referred to as deep learning.

Still referring to FIG. 3, machine-learning algorithms may include at least a supervised machine-learning process 328. At least a supervised machine-learning process 328, as defined herein, include algorithms that receive a training set relating a number of inputs to a number of outputs, and seek to generate one or more data structures representing and/or instantiating one or more mathematical relations relating inputs to outputs, where each of the one or more mathematical relations is optimal according to some criterion specified to the algorithm using some scoring function. For instance, a supervised learning algorithm may include token data 132, user data 136, primary instrument data 124, secondary instrument data 128, updated token data 140, updated secondary instrument data 144, or the like as described above as inputs, program datum 152 as outputs, and a scoring function representing a desired form of relationship to be detected between inputs and outputs; scoring function may, for instance, seek to maximize the probability that a given input and/or combination of elements inputs is associated with a given output to minimize the probability that a given input is not associated with a given output. Scoring function may be expressed as a risk function representing an “expected loss” of an algorithm relating inputs to outputs, where loss is computed as an error function representing a degree to which a prediction generated by the relation is incorrect when compared to a given input-output pair provided in training data 304. Persons skilled in the art, upon reviewing the entirety of this disclosure, will be aware of various possible variations of at least a supervised machine-learning process 328 that may be used to determine relation between inputs and outputs. Supervised machine-learning processes may include classification algorithms as defined above.

With further reference to FIG. 3, training a supervised machine-learning process may include, without limitation, iteratively updating coefficients, biases, weights based on an error function, expected loss, and/or risk function. For instance, an output generated by a supervised machine-learning model using an input example in a training example may be compared to an output example from the training example; an error function may be generated based on the comparison, which may include any error function suitable for use with any machine-learning algorithm described in this disclosure, including a square of a difference between one or more sets of compared values or the like. Such an error function may be used in turn to update one or more weights, biases, coefficients, or other parameters of a machine-learning model through any suitable process including without limitation gradient descent processes, least-squares processes, and/or other processes described in this disclosure. This may be done iteratively and/or recursively to gradually tune such weights, biases, coefficients, or other parameters. Updating may be performed, in neural networks, using one or more back-propagation algorithms. Iterative and/or recursive updates to weights, biases, coefficients, or other parameters as described above may be performed until currently available training data is exhausted and/or until a convergence test is passed, where a “convergence test” is a test for a condition selected as indicating that a model and/or weights, biases, coefficients, or other parameters thereof has reached a degree of accuracy. A convergence test may, for instance, compare a difference between two or more successive errors or error function values, where differences below a threshold amount may be taken to indicate convergence. Alternatively or additionally, one or more errors and/or error function values evaluated in training iterations may be compared to a threshold.

Still referring to FIG. 3, a computing device, processor, and/or module may be configured to perform method, method step, sequence of method steps and/or algorithm described in reference to this figure, in any order and with any degree of repetition. For instance, a computing device, processor, and/or module may be configured to perform a single step, sequence and/or algorithm repeatedly until a desired or commanded outcome is achieved; repetition of a step or a sequence of steps may be performed iteratively and/or recursively using outputs of previous repetitions as inputs to subsequent repetitions, aggregating inputs and/or outputs of repetitions to produce an aggregate result, reduction or decrement of one or more variables such as global variables, and/or division of a larger processing task into a set of iteratively addressed smaller processing tasks. A computing device, processor, and/or module may perform any step, sequence of steps, or algorithm in parallel, such as simultaneously and/or substantially simultaneously performing a step two or more times using two or more parallel threads, processor cores, or the like; division of tasks between parallel threads and/or processes may be performed according to any protocol suitable for division of tasks between iterations. Persons skilled in the art, upon reviewing the entirety of this disclosure, will be aware of various ways in which steps, sequences of steps, processing tasks, and/or data may be subdivided, shared, or otherwise dealt with using iteration, recursion, and/or parallel processing.

Further referring to FIG. 3, machine learning processes may include at least an unsupervised machine-learning processes 332. An unsupervised machine-learning process, as used herein, is a process that derives inferences in datasets without regard to labels; as a result, an unsupervised machine-learning process may be free to discover any structure, relationship, and/or correlation provided in the data. Unsupervised processes 332 may not require a response variable; unsupervised processes 332 may be used to find interesting patterns and/or inferences between variables, to determine a degree of correlation between two or more variables, or the like.

Still referring to FIG. 3, machine-learning module 300 may be designed and configured to create a machine-learning model 324 using techniques for development of linear regression models. Linear regression models may include ordinary least squares regression, which aims to minimize the square of the difference between predicted outcomes and actual outcomes according to an appropriate norm for measuring such a difference (e.g. a vector-space distance norm); coefficients of the resulting linear equation may be modified to improve minimization. Linear regression models may include ridge regression methods, where the function to be minimized includes the least-squares function plus term multiplying the square of each coefficient by a scalar amount to penalize large coefficients. Linear regression models may include least absolute shrinkage and selection operator (LASSO) models, in which ridge regression is combined with multiplying the least-squares term by a factor of 1 divided by double the number of samples. Linear regression models may include a multi-task lasso model wherein the norm applied in the least-squares term of the lasso model is the Frobenius norm amounting to the square root of the sum of squares of all terms. Linear regression models may include the clastic net model, a multi-task elastic net model, a least angle regression model, a LARS lasso model, an orthogonal matching pursuit model, a Bayesian regression model, a logistic regression model, a stochastic gradient descent model, a perceptron model, a passive aggressive algorithm, a robustness regression model, a Huber regression model, or any other suitable model that may occur to persons skilled in the art upon reviewing the entirety of this disclosure. Linear regression models may be generalized in an embodiment to polynomial regression models, whereby a polynomial equation (e.g. a quadratic, cubic or higher-order equation) providing a best predicted output/actual output fit is sought; similar methods to those described above may be applied to minimize error functions, as will be apparent to persons skilled in the art upon reviewing the entirety of this disclosure.

Continuing to refer to FIG. 3, machine-learning algorithms may include, without limitation, linear discriminant analysis. Machine-learning algorithm may include quadratic discriminant analysis. Machine-learning algorithms may include kernel ridge regression. Machine-learning algorithms may include support vector machines, including without limitation support vector classification-based regression processes. Machine-learning algorithms may include stochastic gradient descent algorithms, including classification and regression algorithms based on stochastic gradient descent. Machine-learning algorithms may include nearest neighbors algorithms. Machine-learning algorithms may include various forms of latent space regularization such as variational regularization. Machine-learning algorithms may include Gaussian processes such as Gaussian Process Regression. Machine-learning algorithms may include cross-decomposition algorithms, including partial least squares and/or canonical correlation analysis. Machine-learning algorithms may include naïve Bayes methods. Machine-learning algorithms may include algorithms based on decision trees, such as decision tree classification or regression algorithms. Machine-learning algorithms may include ensemble methods such as bagging meta-estimator, forest of randomized trees, AdaBoost, gradient tree boosting, and/or voting classifier methods. Machine-learning algorithms may include neural net algorithms, including convolutional neural net processes.

Still referring to FIG. 3, a machine-learning model and/or process may be deployed or instantiated by incorporation into a program, apparatus, system and/or module. For instance, and without limitation, a machine-learning model, neural network, and/or some or all parameters thereof may be stored and/or deployed in any memory or circuitry. Parameters such as coefficients, weights, and/or biases may be stored as circuit-based constants, such as arrays of wires and/or binary inputs and/or outputs set at logic “1” and “0” voltage levels in a logic circuit to represent a number according to any suitable encoding system including twos complement or the like or may be stored in any volatile and/or non-volatile memory. Similarly, mathematical operations and input and/or output of data to or from models, neural network layers, or the like may be instantiated in hardware circuitry and/or in the form of instructions in firmware, machine-code such as binary operation code instructions, assembly language, or any higher-order programming language. Any technology for hardware and/or software instantiation of memory, instructions, data structures, and/or algorithms may be used to instantiate a machine-learning process and/or model, including without limitation any combination of production and/or configuration of non-reconfigurable hardware elements, circuits, and/or modules such as without limitation ASICs, production and/or configuration of reconfigurable hardware elements, circuits, and/or modules such as without limitation FPGAs, production and/or of non-reconfigurable and/or configuration non-rewritable memory elements, circuits, and/or modules such as without limitation non-rewritable ROM, production and/or configuration of reconfigurable and/or rewritable memory elements, circuits, and/or modules such as without limitation rewritable ROM or other memory technology described in this disclosure, and/or production and/or configuration of any computing device and/or component thereof as described in this disclosure. Such deployed and/or instantiated machine-learning model and/or algorithm may receive inputs from any other process, module, and/or component described in this disclosure, and produce outputs to any other process, module, and/or component described in this disclosure.

Continuing to refer to FIG. 3, any process of training, retraining, deployment, and/or instantiation of any machine-learning model and/or algorithm may be performed and/or repeated after an initial deployment and/or instantiation to correct, refine, and/or improve the machine-learning model and/or algorithm. Such retraining, deployment, and/or instantiation may be performed as a periodic or regular process, such as retraining, deployment, and/or instantiation at regular elapsed time periods, after some measure of volume such as a number of bytes or other measures of data processed, a number of uses or performances of processes described in this disclosure, or the like, and/or according to a software, firmware, or other update schedule. Alternatively or additionally, retraining, deployment, and/or instantiation may be event-based, and may be triggered, without limitation, by user inputs indicating sub-optimal or otherwise problematic performance and/or by automated field testing and/or auditing processes, which may compare outputs of machine-learning models and/or algorithms, and/or errors and/or error functions thereof, to any thresholds, convergence tests, or the like, and/or may compare outputs of processes described herein to similar thresholds, convergence tests or the like. Event-based retraining, deployment, and/or instantiation may alternatively or additionally be triggered by receipt and/or generation of one or more new training examples; a number of new training examples may be compared to a preconfigured threshold, where exceeding the preconfigured threshold may trigger retraining, deployment, and/or instantiation.

Still referring to FIG. 3, retraining and/or additional training may be performed using any process for training described above, using any currently or previously deployed version of a machine-learning model and/or algorithm as a starting point. Training data for retraining may be collected, preconditioned, sorted, classified, sanitized or otherwise processed according to any process described in this disclosure. Training data may include, without limitation, training examples including inputs and correlated outputs used, received, and/or generated from any version of any system, module, machine-learning model or algorithm, apparatus, and/or method described in this disclosure; such examples may be modified and/or labeled according to user feedback or other processes to indicate desired results, and/or may have actual or measured results from a process being modeled and/or predicted by system, module, machine-learning model or algorithm, apparatus, and/or method as “desired” results to be compared to outputs for training processes as described above.

Redeployment may be performed using any reconfiguring and/or rewriting of reconfigurable and/or rewritable circuit and/or memory elements; alternatively, redeployment may be performed by production of new hardware and/or software components, circuits, instructions, or the like, which may be added to and/or may replace existing hardware and/or software components, circuits, instructions, or the like.

Further referring to FIG. 3, one or more processes or algorithms described above may be performed by at least a dedicated hardware unit 336. A “dedicated hardware unit,” for the purposes of this figure, is a hardware component, circuit, or the like, aside from a principal control circuit and/or processor performing method steps as described in this disclosure, that is specifically designated or selected to perform one or more specific tasks and/or processes described in reference to this figure, such as without limitation preconditioning and/or sanitization of training data and/or training a machine-learning algorithm and/or model. A dedicated hardware unit 336 may include, without limitation, a hardware unit that can perform iterative or massed calculations, such as matrix-based calculations to update or tune parameters, weights, coefficients, and/or biases of machine-learning models and/or neural networks, efficiently using pipelining, parallel processing, or the like; such a hardware unit may be optimized for such processes by, for instance, including dedicated circuitry for matrix and/or signal processing operations that includes, e.g., multiple arithmetic and/or logical circuit units such as multipliers and/or adders that can act simultaneously and/or in parallel or the like. Such dedicated hardware units 336 may include, without limitation, graphical processing units (GPUs), dedicated signal processing modules, FPGA or other reconfigurable hardware that has been configured to instantiate parallel processing units for one or more specific tasks, or the like, A computing device, processor, apparatus, or module may be configured to instruct one or more dedicated hardware units 336 to perform one or more operations described herein, such as evaluation of model and/or algorithm outputs, one-time or iterative updates to parameters, coefficients, weights, and/or biases, and/or any other operations such as vector and/or matrix operations as described in this disclosure.

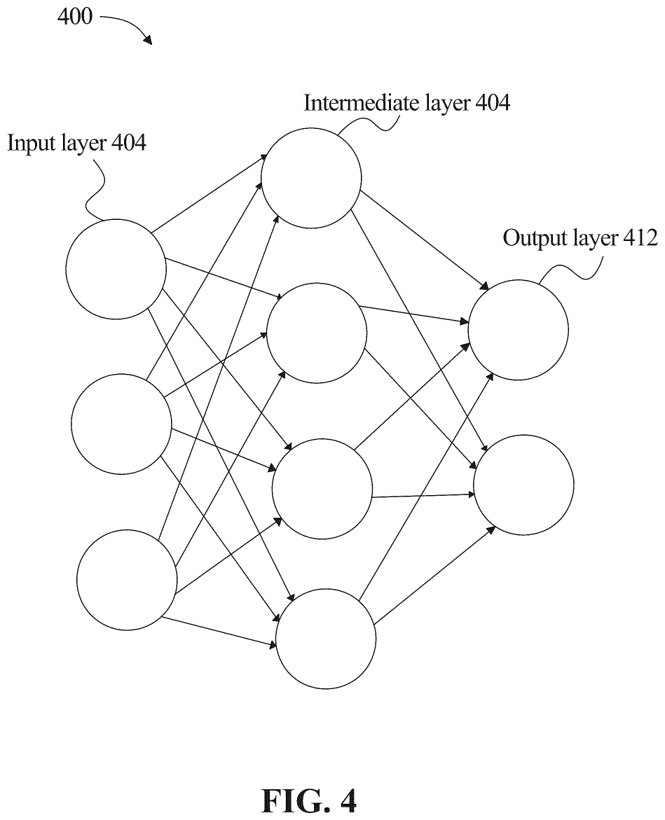

Referring now to FIG. 4, an exemplary embodiment of neural network 400 is illustrated. A neural network 400 also known as an artificial neural network, is a network of “nodes,” or data structures having one or more inputs, one or more outputs, and a function determining outputs based on inputs. Such nodes may be organized in a network, such as without limitation a convolutional neural network, including an input layer of nodes 404, one or more intermediate layers 408, and an output layer of nodes 412. Connections between nodes may be created via the process of “training” the network, in which elements from a training dataset are applied to the input nodes, a suitable training algorithm (such as Levenberg-Marquardt, conjugate gradient, simulated annealing, or other algorithms) is then used to adjust the connections and weights between nodes in adjacent layers of the neural network to produce the desired values at the output nodes. This process is sometimes referred to as deep learning. Connections may run solely from input nodes toward output nodes in a “feed-forward” network, or may feed outputs of one layer back to inputs of the same or a different layer in a “recurrent network.” As a further non-limiting example, a neural network may include a convolutional neural network comprising an input layer of nodes, one or more intermediate layers, and an output layer of nodes. A “convolutional neural network,” as used in this disclosure, is a neural network in which at least one hidden layer is a convolutional layer that convolves inputs to that layer with a subset of inputs known as a “kernel,” along with one or more additional layers such as pooling layers, fully connected layers, and the like.

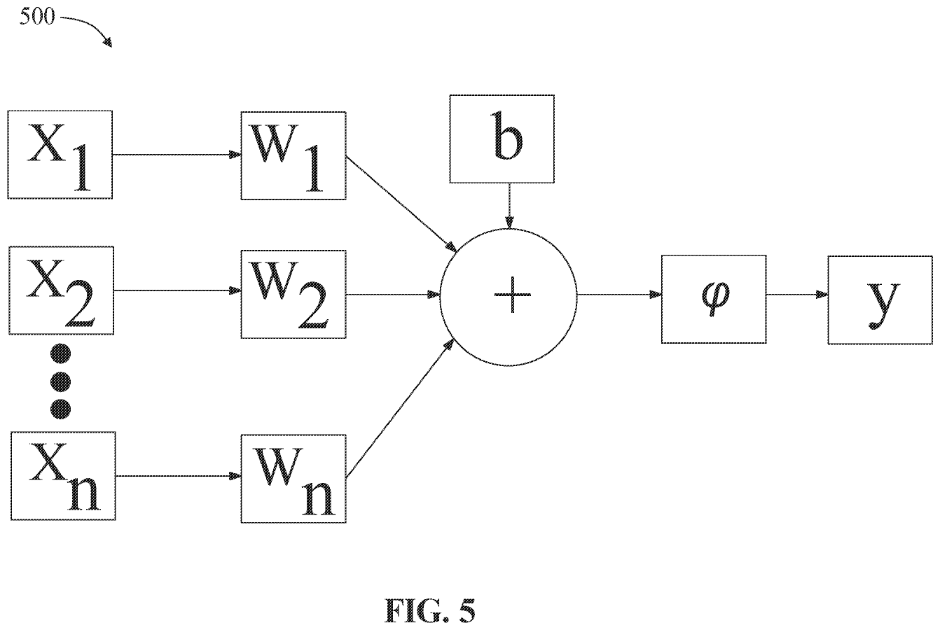

Referring now to FIG. 5 an exemplary embodiment of a node 500 of a neural network is illustrated. A node may include, without limitation, a plurality of inputs x; that may receive numerical values from inputs to a neural network containing the node and/or from other nodes. Node may perform one or more activation functions to produce its output given one or more inputs, such as without limitation computing a binary step function comparing an input to a threshold value and outputting either a logic 1 or logic 0 output or something equivalent, a linear activation function whereby an output is directly proportional to the input, and/or a non-linear activation function, wherein the output is not proportional to the input. Non-linear activation functions may include, without limitation, a sigmoid function of the form

$$f ( x ) = \frac{1}{1 - {e}^{- x}}$$

given input x, a tanh (hyperbolic tangent) function, of the form

$$\frac{{e}^{x} - {e}^{- x}}{{e}^{x} + {e}^{- x}} ,$$

a tanh derivative function such as ƒ(x)=tanh²(x), a rectified linear unit function such as ƒ(x)=max(0, x), a “leaky” and/or “parametric” rectified linear unit function such as ƒ(x)=max(ax, x) for some a, an exponential linear units function such as

$$f ( x ) = \{ \begin{matrix}x for x \geq 0 \\ α ( {e}^{x} - 1 ) for x < 0\end{matrix}$$

for some value of α (this function may be replaced and/or weighted by its own derivative in some embodiments), a softmax function such as

$$f ( {x}_{i} ) = \frac{{e}^{x}}{{\sum }_{i} {x}_{i}}$$

where the inputs to an instant layer are xᵢ, a swish function such as ƒ(x)=x*sigmoid(x), a Gaussian error linear unit function such as f(x)=a(1+tanh(\sqrt{2/π}(x+bx^{r}))) for some values of a, b, and r, and/or a scaled exponential linear unit function such as

$$f ( x ) = λ \{ \begin{matrix}α ( {e}^{x} - 1 ) for x < 0 \\ x for x \geq 0\end{matrix} .$$

Fundamentally, there is no limit to the nature of functions of inputs xᵢ that may be used as activation functions. As a non-limiting and illustrative example, node may perform a weighted sum of inputs using weights wᵢ that are multiplied by respective inputs xᵢ. Additionally or alternatively, a bias b may be added to the weighted sum of the inputs such that an offset is added to each unit in the neural network layer that is independent of the input to the layer. The weighted sum may then be input into a function φ, which may generate one or more outputs y. Weight wᵢ applied to an input xᵢ may indicate whether the input is “excitatory,” indicating that it has strong influence on the one or more outputs y, for instance by the corresponding weight having a large numerical value, and/or a “inhibitory,” indicating it has a weak effect influence on the one more inputs y, for instance by the corresponding weight having a small numerical value. The values of weights wᵢ may be determined by training a neural network using training data, which may be performed using any suitable process as described above.

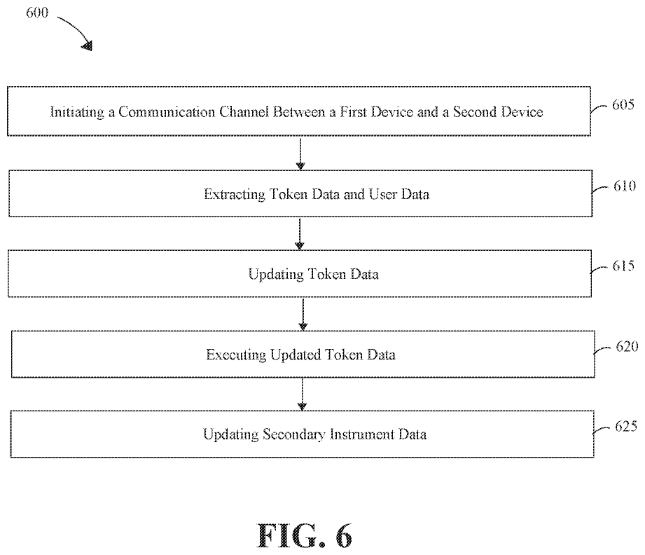

Referring now to FIG. 6, a flow diagram of an exemplary method 600 of executing token data is illustrated. Method 600 includes a step 605 of initiating, using at least a processor, a communication channel between a first device and a second device. In some embodiments, the communication channel may include near field communication. These may be implemented as described with reference to FIGS. 1-5.

With continued reference to FIG. 6, method 600 includes a step 610 of extracting, using the at least a processor, token data and user data using the communication channel, wherein the user data includes primary instrument data and secondary instrument data. These may be implemented as described with reference to FIGS. 1-5.

With continued reference to FIG. 6, method 600 includes a step 615 of updating, using at least a processor, token data as a function of user data. In some embodiments, method 600 may further include determining, using the at least a processor, a program datum as a function of the token data and the user data and updating, using the at least a processor, the token data as a function of the program datum. In some embodiments, method 600 may further include determining, using the at least a processor, the program datum as a function of a hierarchy level of the secondary instrument data of the user data. In some embodiments, method 600 may further include verifying, using the at least a processor, the secondary instrument data using a checksum. In some embodiments, method 600 may further include updating, using the at least a processor, the token data as a function of the user input, wherein the user input includes a portion of an accumulated execution number of the secondary instrument data of the user data. In some embodiments, method 600 may further include rejecting, using the at least a processor, to update the token data as a function of the user input when the portion of the accumulated execution number of the user input exceeds the accumulated execution number of the secondary instrument data. These may be implemented as described with reference to FIGS. 1-5.

With continued reference to FIG. 6, method 600 includes a step 620 of executing, using at least a processor, updated token data as a function of primary instrument data of user data. In some embodiments, method 600 may further include receiving, using the at least a processor, a user input as a function of the updated token data and executing, using the at least a processor, the updated token data as a function of the user input. These may be implemented as described with reference to FIGS. 1-5.

With continued reference to FIG. 6, method 600 includes a step 625 of updating, using at least a processor, secondary instrument data of user data as a function of execution of updated token data. In some embodiments, method 600 may further include displaying, using the at least a processor, the updated token data on the first device. In some embodiments, method 600 may further include generating, using the at least a processor, an alert datum as a function of the execution of the updated token data and transmitting, using the at least a processor, the alert datum to the second device. These may be implemented as described with reference to FIGS. 1-5.

It is to be noted that any one or more of the aspects and embodiments described herein may be conveniently implemented using one or more machines (e.g., one or more computing devices that are utilized as a user computing device for an electronic document, one or more server devices, such as a document server, etc.) programmed according to the teachings of the present specification, as will be apparent to those of ordinary skill in the computer art. Appropriate software coding can readily be prepared by skilled programmers based on the teachings of the present disclosure, as will be apparent to those of ordinary skill in the software art. Aspects and implementations discussed above employing software and/or software modules may also include appropriate hardware for assisting in the implementation of the machine executable instructions of the software and/or software module.

Such software may be a computer program product that employs a machine-readable storage medium. A machine-readable storage medium may be any medium that is capable of storing and/or encoding a sequence of instructions for execution by a machine (e.g., a computing device) and that causes the machine to perform any one of the methodologies and/or embodiments described herein. Examples of a machine-readable storage medium include, but are not limited to, a magnetic disk, an optical disc (e.g., CD, CD-R, DVD, DVD-R, etc.), a magneto-optical disk, a read-only memory “ROM” device, a random access memory “RAM” device, a magnetic card, an optical card, a solid-state memory device, an EPROM, an EEPROM, and any combinations thereof. A machine-readable medium, as used herein, is intended to include a single medium as well as a collection of physically separate media, such as, for example, a collection of compact discs or one or more hard disk drives in combination with a computer memory. As used herein, a machine-readable storage medium does not include transitory forms of signal transmission.

Such software may also include information (e.g., data) carried as a data signal on a data carrier, such as a carrier wave. For example, machine-executable information may be included as a data-carrying signal embodied in a data carrier in which the signal encodes a sequence of instruction, or portion thereof, for execution by a machine (e.g., a computing device) and any related information (e.g., data structures and data) that causes the machine to perform any one of the methodologies and/or embodiments described herein.

Examples of a computing device include, but are not limited to, an electronic book reading device, a computer workstation, a terminal computer, a server computer, a handheld device (e.g., a tablet computer, a smartphone, etc.), a web appliance, a network router, a network switch, a network bridge, any machine capable of executing a sequence of instructions that specify an action to be taken by that machine, and any combinations thereof. In one example, a computing device may include and/or be included in a kiosk.

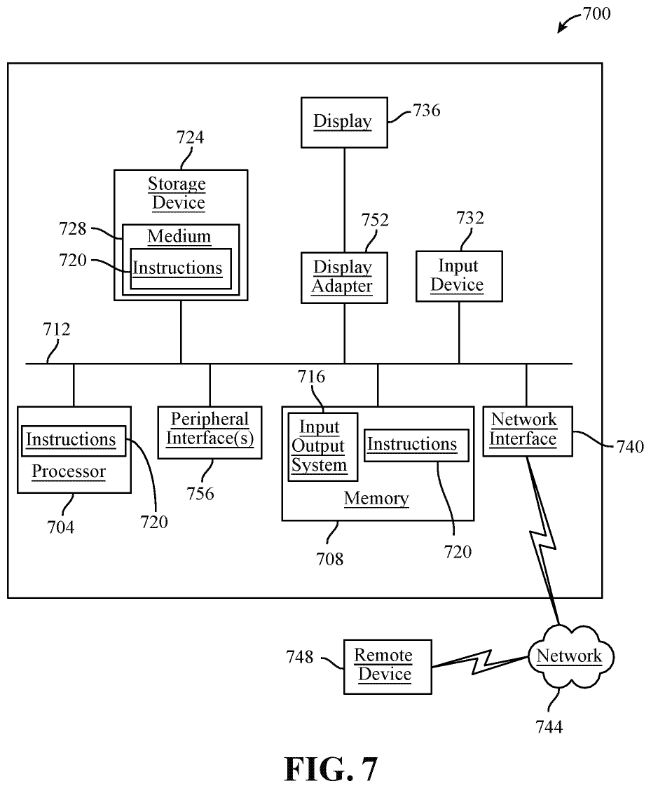

FIG. 7 shows a diagrammatic representation of one embodiment of a computing device in the exemplary form of a computer system 700 within which a set of instructions for causing a control system to perform any one or more of the aspects and/or methodologies of the present disclosure may be executed. It is also contemplated that multiple computing devices may be utilized to implement a specially configured set of instructions for causing one or more of the devices to perform any one or more of the aspects and/or methodologies of the present disclosure. Computer system 700 includes a processor 704 and memory 708 that communicate with each other, and with other components, via a bus 712. Bus 712 may include any of several types of bus structures including, but not limited to, memory bus, memory controller, a peripheral bus, a local bus, and any combinations thereof, using any of a variety of bus architectures.

Processor 704 may include any suitable processor, such as without limitation a processor incorporating logical circuitry for performing arithmetic and logical operations, such as an arithmetic and logic unit (ALU), which may be regulated with a state machine and directed by operational inputs from memory and/or sensors; processor 704 may be organized according to Von Neumann and/or Harvard architecture as a non-limiting example. Processor 704 may include, incorporate, and/or be incorporated in, without limitation, a microcontroller, microprocessor, digital signal processor (DSP), Field Programmable Gate Array (FPGA), Complex Programmable Logic Device (CPLD), Graphical Processing Unit (GPU), general purpose GPU, Tensor Processing Unit (TPU), analog or mixed signal processor, Trusted Platform Module (TPM), a floating point unit (FPU), and/or system on a chip (SoC).

Memory 708 may include various components (e.g., machine-readable media) including, but not limited to, a random-access memory component, a read only component, and any combinations thereof. In one example, a basic input/output system 716 (BIOS), including basic routines that help to transfer information between elements within computer system 700, such as during start-up, may be stored in memory 708. Memory 708 may also include (e.g., stored on one or more machine-readable media) instructions (e.g., software) 720 embodying any one or more of the aspects and/or methodologies of the present disclosure. In another example, memory 708 may further include any number of program modules including, but not limited to, an operating system, one or more application programs, other program modules, program data, and any combinations thereof.

Computer system 700 may also include a storage device 724. Examples of a storage device (e.g., storage device 724) include, but are not limited to, a hard disk drive, a magnetic disk drive, an optical disc drive in combination with an optical medium, a solid-state memory device, and any combinations thereof. Storage device 724 may be connected to bus 712 by an appropriate interface (not shown). Example interfaces include, but are not limited to, SCSI, advanced technology attachment (ATA), serial ATA, universal serial bus (USB), IEEE 1394 (FIREWIRE), and any combinations thereof. In one example, storage device 724 (or one or more components thereof) may be removably interfaced with computer system 700 (e.g., via an external port connector (not shown)). Particularly, storage device 724 and an associated machine-readable medium 728 may provide nonvolatile and/or volatile storage of machine-readable instructions, data structures, program modules, and/or other data for computer system 700. In one example, software 720 may reside, completely or partially, within machine-readable medium 728. In another example, software 720 may reside, completely or partially, within processor 704.

Computer system 700 may also include an input device 732. In one example, a user of computer system 700 may enter commands and/or other information into computer system 700 via input device 732. Examples of an input device 732 include, but are not limited to, an alpha-numeric input device (e.g., a keyboard), a pointing device, a joystick, a gamepad, an audio input device (e.g., a microphone, a voice response system, etc.), a cursor control device (e.g., a mouse), a touchpad, an optical scanner, a video capture device (e.g., a still camera, a video camera), a touchscreen, and any combinations thereof. Input device 732 may be interfaced to bus 712 via any of a variety of interfaces (not shown) including, but not limited to, a serial interface, a parallel interface, a game port, a USB interface, a FIREWIRE interface, a direct interface to bus 712, and any combinations thereof. Input device 732 may include a touch screen interface that may be a part of or separate from display 736, discussed further below. Input device 732 may be utilized as a user selection device for selecting one or more graphical representations in a graphical interface as described above.

A user may also input commands and/or other information to computer system 700 via storage device 724 (e.g., a removable disk drive, a flash drive, etc.) and/or network interface device 740. A network interface device, such as network interface device 740, may be utilized for connecting computer system 700 to one or more of a variety of networks, such as network 744, and one or more remote devices 748 connected thereto. Examples of a network interface device include, but are not limited to, a network interface card (e.g., a mobile network interface card, a LAN card), a modem, and any combination thereof. Examples of a network include, but are not limited to, a wide area network (e.g., the Internet, an enterprise network), a local area network (e.g., a network associated with an office, a building, a campus or other relatively small geographic space), a telephone network, a data network associated with a telephone/voice provider (e.g., a mobile communications provider data and/or voice network), a direct connection between two computing devices, and any combinations thereof. A network, such as network 744, may employ a wired and/or a wireless mode of communication. In general, any network topology may be used. Information (e.g., data, software 720, etc.) may be communicated to and/or from computer system 700 via network interface device 740.

Computer system 700 may further include a video display adapter 752 for communicating a displayable image to a display device, such as display device 736. Examples of a display device include, but are not limited to, a liquid crystal display (LCD), a cathode ray tube (CRT), a plasma display, a light emitting diode (LED) display, and any combinations thereof. Display adapter 752 and display device 736 may be utilized in combination with processor 704 to provide graphical representations of aspects of the present disclosure. In addition to a display device, computer system 700 may include one or more other peripheral output devices including, but not limited to, an audio speaker, a printer, and any combinations thereof. Such peripheral output devices may be connected to bus 712 via a peripheral interface 756. Examples of a peripheral interface include, but are not limited to, a serial port, a USB connection, a FIREWIRE connection, a parallel connection, and any combinations thereof.

The foregoing has been a detailed description of illustrative embodiments of the invention. Various modifications and additions can be made without departing from the spirit and scope of this invention. Features of each of the various embodiments described above may be combined with features of other described embodiments as appropriate in order to provide a multiplicity of feature combinations in associated new embodiments. Furthermore, while the foregoing describes a number of separate embodiments, what has been described herein is merely illustrative of the application of the principles of the present invention. Additionally, although particular methods herein may be illustrated and/or described as being performed in a specific order, the ordering is highly variable within ordinary skill to achieve methods and apparatuses according to the present disclosure. Accordingly, this description is meant to be taken only by way of example, and not to otherwise limit the scope of this invention.

Exemplary embodiments have been disclosed above and illustrated in the accompanying drawings. It will be understood by those skilled in the art that various changes, omissions and additions may be made to that which is specifically disclosed herein without departing from the spirit and scope of the present invention.

1. An apparatus for executing token data, the apparatus comprising:
at least a processor; and
a memory communicatively connected to the at least a processor, wherein the memory contains instructions configuring the at least a processor to:
initiate a communication channel between a first device and a second device;
extract the token data and user data using the communication channel, wherein the user data comprises primary instrument data and secondary instrument data;
determine a program datum as a function of the token data and the user data,
wherein determining the program data further comprises:
receiving a plurality of candidate training data correlating user data examples to program data examples;
selecting training data from the plurality of candidate data, wherein selecting the training data further comprises classifying the training data to the user data;
training a machine-learning model using the classified training data and a machine-learning algorithm; and
determining the program datum using the trained machine-learning model;
update the token data as a function of the program datum;
receive a user input as a function of the updated token data indicating confirmation or rejection of the updated token data;
execute the updated token data as a function of the primary instrument data of the user data and the user input; and
update the secondary instrument data of the user data as a function of the execution of the updated token data, wherein updating the secondary instrument data includes increasing or decreasing a value of the secondary instrument data according to the execution of the updated token data.

2. The apparatus of claim 1, wherein the communication channel comprises near field communication.

3. (canceled)

4. The apparatus of claim 1, wherein:
the secondary instrument data of the user data comprises a hierarchy level; and
the memory contains instructions further configuring the at least a processor to determine the program datum as a function of the hierarchy level.

5. The apparatus of claim 1, wherein the memory contains instructions further configuring the at least a processor to verify the secondary instrument data using a cryptographic hash function.

6. The apparatus of claim 1, wherein the memory contains instructions further configuring the at least a processor to:
receive a user input as a function of the updated token data; and
execute the updated token data as a function of the user input.

7. The apparatus of claim 6, wherein:
the secondary instrument data of the user data comprises an accumulated execution number; and
the memory contains instructions further configuring the at least a processor to update the token data as a function of the user input, wherein the user input comprises a portion of the accumulated execution number.

8. The apparatus of claim 7, wherein the memory contains instructions further configuring the at least a processor to reject to update the token data as a function of the user input when the portion of the accumulated execution number of the user input exceeds the accumulated execution number of the secondary instrument data.

9. The apparatus of claim 1, wherein the memory contains instructions further configuring the at least a processor to display the updated token data on the first device.

10. The apparatus of claim 1, wherein the memory contains instructions further configuring the at least a processor to:
generate an alert datum as a function of the execution of the updated token data; and
transmit the alert datum to the second device.

11. A method for executing token data, the method comprising:
initiating, using at least a processor, a communication channel between a first device and a second device;
extracting, using the at least a processor, the token data and user data using the communication channel, wherein the user data comprises primary instrument data and secondary instrument data;
determining, using the at least a processor, a program datum as a function of the token data and the user data using a machine-learning model, wherein
determining the program data further comprises:
receiving a plurality of candidate training data correlating user data examples to program data examples;
selecting training data from the plurality of candidate data, wherein selecting the training data further comprises classifying the training data to the user data;
training a machine-learning model using the classified training data and a machine-learning algorithm; and
determining the program datum using the trained machine-learning model;
updating, using the at least a processor, the token data as a function of the program datum;
receiving a user input as a function of the updated token data indicating confirmation or rejection of the updated token data;
executing, using the at least a processor, the updated token data as a function of the primary instrument data of the user data and the user input; and
updating, using the at least a processor, the secondary instrument data of the user data as a function of the execution of the updated token data, wherein updating the secondary instrument data includes increasing or decreasing a value of the secondary instrument data according to the execution of the updated token data.

12. The method of claim 11, wherein the communication channel comprises near field communication.

13. (canceled)

14. The method of claim 11, wherein:
determining, using the at least a processor, the program datum as a function of a hierarchy level of the secondary instrument data of the user data.

15. The method of claim 11, further comprising:
verifying, using the at least a processor, the secondary instrument data using a cryptographic hash function.

16. The method of claim 11, further comprising:
receiving, using the at least a processor, a user input as a function of the updated token data; and
executing, using the at least a processor, the updated token data as a function of the user input.

17. The method of claim 16, wherein:
updating, using the at least a processor, the token data as a function of the user input, wherein the user input comprises a portion of an accumulated execution number of the secondary instrument data of the user data.

18. The method of claim 17, further comprising:
rejecting, using the at least a processor, to update the token data as a function of the user input when the portion of the accumulated execution number of the user input exceeds the accumulated execution number of the secondary instrument data.

19. The method of claim 11, further comprising:
displaying, using the at least a processor, the updated token data on the first device.

20. The method of claim 11, further comprising:
generating, using the at least a processor, an alert datum as a function of the execution of the updated token data; and
transmitting, using the at least a processor, the alert datum to the second device.

21. The apparatus of claim 1, wherein determining the program datum further comprises:
receiving training data correlating a plurality of token data and a plurality of user data to a plurality of program datums;
sanitizing the training data;
training the machine-learning model using the sanitized training data; and
determining the program datum as a function of the token data and the user data using the trained machine-learning model.

22. The method of claim 11, wherein determining the program datum further comprises:
receiving training data correlating a plurality of token data and a plurality of user data to a plurality of program datums;
sanitizing the training data;
training the machine-learning model using the sanitized training data; and
determining the program datum as a function of the token data and the user data using the trained machine-learning model.
